(19) United States
(12) Patent Application Publication
(10) Pub. No.: US 2015/0227661 A1
(43) Pub. Date: Aug. 13, 2015

(54) COMPUTER PRODUCT, SIMULATION APPARATUS, SIMULATION METHOD, BUS MODEL, AND BUS CIRCUIT

(71) Applicant: FUJITSU LIMITED, Kawasaki-shi (JP)

(72) Inventor: Takayuki SASAKI, Kawasaki (JP)

(73) Assignee: FUJITSU LIMITED, Kawasaki (JP)

(21) Appl. No.: 14/691,860

(22) Filed: Apr. 21, 2015

Related U.S. Application Data
(63) Continuation of application No. PCT/JP2012/077519, filed on Oct. 24, 2012.

(51) Int. Cl. G06F 17/50

(52) U.S. Cl. CPC G06F 17/5022

(57) ABSTRACT

A non-transitory, computer-readable recording medium stores therein a simulation program that causes a computer to execute a process that includes obtaining an architecture model that includes a scenario block that issues an invocation signal to blocks and detects an end signal from the blocks, a bus model that connects the blocks and a memory model and that controls access from the blocks to the memory model, and the blocks that access the memory model via the bus model and perform a calculation process; obtaining for each block, scenario description that indicates a count of the calculation process performed for a series of processes, a cycle count consumed for the calculation process, a read data volume for the calculation process, a write data volume for the calculation process, and an operation frequency of the block; and executing simulation of the architecture model based on the architecture model and the scenario description.

### CROSS REFERENCE TO RELATED APPLICATIONS

This application is a continuation application of International Application PCT/JP2012/077519, filed on Oct. 24, 2012 and designating the U.S., the entire contents of which are incorporated herein by reference.

### FIELD

The embodiments discussed herein are related to a computer product, a simulation apparatus, a simulation method, a bus model, and a bus circuit.

### BACKGROUND

Conventionally, system performance may be evaluated by creating a simulation model at a level of a higher abstraction level than register transfer levels (RTL) such as the electronic system level (ESL). Further, a user may use spreadsheet software to make calculations to evaluate system performance.

According to a related technique, for example, the analysis results of a unified modeling language (UML) model are converted according to a user input transformation rule, whereby a performance evaluation model is created. Further, according to another technique, the performance of a system in which plural circuit blocks are connected by a bus is calculated from bus information at the time of software execution and bus operation information held by a part for each circuit block in the system retained in a library. For examples of the above techniques, refer to Japanese Laid-Open Patent Publication Nos. 2001-318812 and 2000-293396.

Nonetheless, with the conventional techniques, a problem arises in that the creation of a simulation model for evaluating system performance is troublesome and time consuming. For example, even with ESL, a period of several months is required to create a simulation model and therefore, evaluating system performance before the design stage (including meeting with the client) is difficult.

Recently, in many cases, various types of hardware blocks are combined to design a system on a chip (SoC) having various types of functions. Therefore, evaluating system performance by using spreadsheet software to make calculations involves theoretical investigation based on the experience and intuition of several specialists and accordingly, involves increased cost and working hours.

### SUMMARY

According to an aspect of an embodiment, a non-transitory, computer-readable recording medium stores therein a simulation program that causes a computer to execute a process that includes obtaining an architecture model that includes a scenario block that issues an invocation signal to blocks and detects an end signal from the blocks, a bus model that connects the blocks and a memory model and that controls access from the blocks to the memory model, and the blocks that access the memory model via the bus model and perform a calculation process; obtaining for each block, scenario description that indicates a count of the calculation process performed for a series of processes, a cycle count consumed for the calculation process, a read data volume for the calculation process, a write data volume for the calculation process, and an operation frequency of the block; and executing simulation of the architecture model based on the architecture model and the scenario description.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams depicting a relation between execution states of tasks and bus flow volume;

FIG. 2 is a diagram depicting an example of description of start_done;

FIG. 3 is a diagram depicting an example of a calculation block;

FIG. 4 is a diagram depicting an example of description of a calculation block;

FIG. 5 is a diagram depicting an example of description of a read interface;

FIG. 6 is a diagram depicting an example of an architecture model;

FIG. 7 is a diagram depicting an example of scenario description of a scenario block SB;

FIG. 8 is a diagram depicting an example of linking description;

FIG. 9 is a block diagram of an example of a hardware configuration of a simulation apparatus 900;

FIG. 10 is a block diagram depicting an example of a functional configuration of the simulation apparatus 900;

FIG. 11 is a diagram depicting an example of execution of simulation;

FIG. 12 is a diagram (part 1) depicting an example of bus protocol;

FIG. 13 is a diagram (part 2) depicting an example of bus protocol;

FIG. 14 is a diagram depicting an example of an arbitration circuit;

FIG. 15 is a diagram depicting an example of a circuit of a trip plan;

FIG. 16 is a diagram depicting an example of an arbitration model;

FIG. 17 is a diagram depicting an example of data transfer;

FIG. 18 is a diagram depicting an example of a class diagram of a trip plan;

FIG. 19 is a diagram depicting an example of a class diagram of route_n_{—}1_t;

FIG. 20 is diagram of an example of a definition of make( ) of route_n_{—}1_t;

FIG. 21 is a diagram depicting a sample example of architecture;

FIG. 22 is a diagram depicting an example of architecture connection description;

FIG. 23 is a diagram depicting an example of circuit description of an initiator;

FIG. 24 is a diagram depicting an example of circuit description of a target;

FIGS. 25 and 26 are diagrams depicting an example of state transition;

FIG. 27 is a class diagram related to structure information;

FIG. 28 is a diagram depicting an output example of component information;

FIG. 29 is a class diagram related to block information;

FIG. 30 is a diagram depicting an example of defining a state;

FIG. 31 is a diagram depicting an example of configuration information;

FIG. 32 is a diagram depicting an example of prober information;

FIG. 33 is a diagram depicting an example of waveform dump;

FIG. 34 is a flowchart depicting an example of a procedure of a simulation process of the simulation apparatus 900;

FIG. 35 is a diagram depicting an example of analysis of simulation execution results; and

FIGS. 36, 37, and 38 are diagrams depicting an example of an architecture simulation analysis viewer.

### DESCRIPTION OF EMBODIMENTS

Embodiments of a simulation program, a simulation apparatus, a simulation method, a bus model, and a bus circuit will be described in detail with reference to the accompanying drawings.

An example of the simulation method according to an embodiment will be described. In the present embodiment, a simulation method that evaluates system performance at a level having a higher abstraction level than RTLs such as the ESL will be described.

A system subject to evaluation, for example, is a system in which plural hardware blocks and memory are connected via a bus. Further, simulation is for confirming based on the state of congestion of the bus when hardware blocks send transactions to the bus, that system performance has not failed.

Here, using a result of netlist emulation, the relation between the execution state of a task of each hardware block in the system and the bus flow volume will be described.

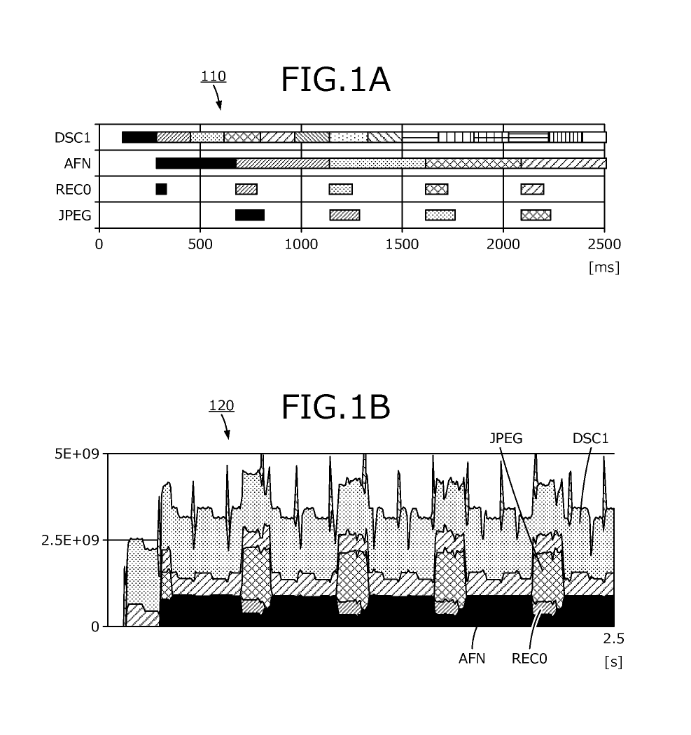

FIGS. 1A and 1B are diagrams depicting the relation between the execution states of tasks and bus flow volume. In FIGS. 1A and 1B, graphs 110 and 120 depict relations between the bus flow volume and the execution state of tasks of hardware blocks extracted from a SoC simulation environment in which various types of past RTL design data are combined.

The bus flow volume is the data volume input to and output from the hardware blocks via the bus. The waveforms in graphs 110 and 120 are on the order of 2.5 seconds; one point of graph 120 has a width on the order of 6 [ms]; and flow rate (for example, [bps/sec]) of this interval is indicated. In FIGS. 1A and 1B, DSC1, AFN, REC0, and JPEG represent the names of hardware blocks.

Graphs 110 and 120 indicate that the amount of overall bus bandwidth used varies according to the task execution state. Further, during the execution period of each task, the waveform of the bus flow volume becomes a waveform that is nearly rectangular. Further, for example, when REC0 and JPEG are operated, the bus flow volume of AFN and REC0 becomes 1/2 or less.

From this, it can be assumed that the bus flow volume is proportionally related to the calculation volume of the hardware blocks and that use of the bus under the same usage state is a steady state (rectangular). Further, if a steady state is assumed irrespective of the execution state, a peripheral hardware block of the bus can be assumed to perform periodic access, as viewed from the sampling interval overall. In addition, an interval for which the used bus bandwidth is smaller than for another execution period can be assumed to be a period during the bus bandwidth is insufficient.

Thus, in the present embodiment, an existing bus model and memory model are used to accurately model to a given extent, the bus portion and the memory portion (for example, dynamic random access memory (DRAM)).

In the logical design for an application having a large data volume, design is such that the continuity of DRAM access can be guaranteed. Therefore, the bus portion, for example, can be defined by the initial address, overhead, and logical burst length (longer than the burst length supported by DRAM). Further, the DRAM portion can be modeled by the specification and therefore, a bus model that simulates DRAM transfer is created.

In the description hereinafter, a hardware block may be simply indicted as “block”. Further, a block that can obtain bus utilization privilege may be indicated as “initiator”, and a block to which the initiator sends data or from which the initiator takes data may be indicated as “target”.

Further, in the present embodiment, a calculation model that reads/writes data of a specified size, causes a delay period of a specified cycle amount, and reproduces the calculation period is used as a block that accesses the memory model via the bus model and performs a calculation process. Further, the developer defines scenarios for expressing execution states of the tasks of the blocks.

A scenario performs the following processes for each block to be invoked. More specifically, for each block, the scenario provides a count of calculations performed by a series of processes, an average calculation cycle count for one calculation, an average read data volume for one calculation, an average write data volume for one calculation, and a cycle; and transmits an invocation signal to the block. Further, the scenario detects an end signal from the block that sent the invocation signal and realizes a desired process by changing the scenario.

Here, a series of processes is a single continuous process considered by the developer to be a set of processes. The unit of the series of processes differs according to the viewpoint of the developer, the application, etc. For example, in the case of a video processing developer, processing for image data (one frame) of one screen may be considered to be one series of processes, or processing for one macroblock (unit into which an image configuring a frame is divided for processing) may be considered one series of processes.

A count of calculations performed by one series of processes is a count of the calculations for one series of the processes. As described above, the granularity of the unit into which a series of processes is divided for processing changes according to the viewpoint of the developer. For example, if the processing of one frame is considered to be one series of processes, the block repeatedly accesses the bus during one frame, obtains the data necessary for the processing by the block, and performs calculations. Therefore, calculation is performed plural times for one series of processes. If architecture is simulated to estimate bus performance, the question arises “if calculation is performed a given number of times for one series of processes, what level of bus performance results?” Here, a count of the calculations for one series of processes in such a case is called a “count of calculations performed by one series of process”.

The average calculation cycle count for one calculation is an average value of the cycle count consumed for one calculation process. In one series of the processes, plural calculations are performed and although the cycle count for a calculation varies, here, the average calculation cycle count for one calculation, for example, is arbitrarily set by the user of the architecture simulation environment. For example, a value given to parameter delay described hereinafter is a value obtained by using the average calculation cycle count for one calculation.

The average read data volume for one calculation is the average data read for one calculation. In one series of processes, plural calculations are performed and although the size of data read for each calculation differs, here, the average read data volume for one calculation, for example, is arbitrarily set by the user of the architecture simulation environment. For example, a value given to a parameter count described hereinafter is a value obtained by using the average read volume for one calculation.

The average write data volume for one calculation is the average data written for one calculation. In one series of processes, plural calculations are performed and although the size of data written for one calculation differs, here, the average write data volume for one calculation, for example, is arbitrarily set by the user of the architecture simulation environment.

Further, the cycle is the operation frequency of the peripheral block. If the operation frequency of the peripheral block changes, processing is performed by writing a given value into a setting register by the processor. In other words, the cycle is to be controlled by the scenario during architecture simulation. A PERIOD described hereinafter, for example, is a parameter name.

In this manner, communication for invocation and termination is necessary between the block that realizes the scenario and the block that performs calculations. Therefore, the developer defines a component that performs communication between the block that realizes the scenario and the block that performs calculations.

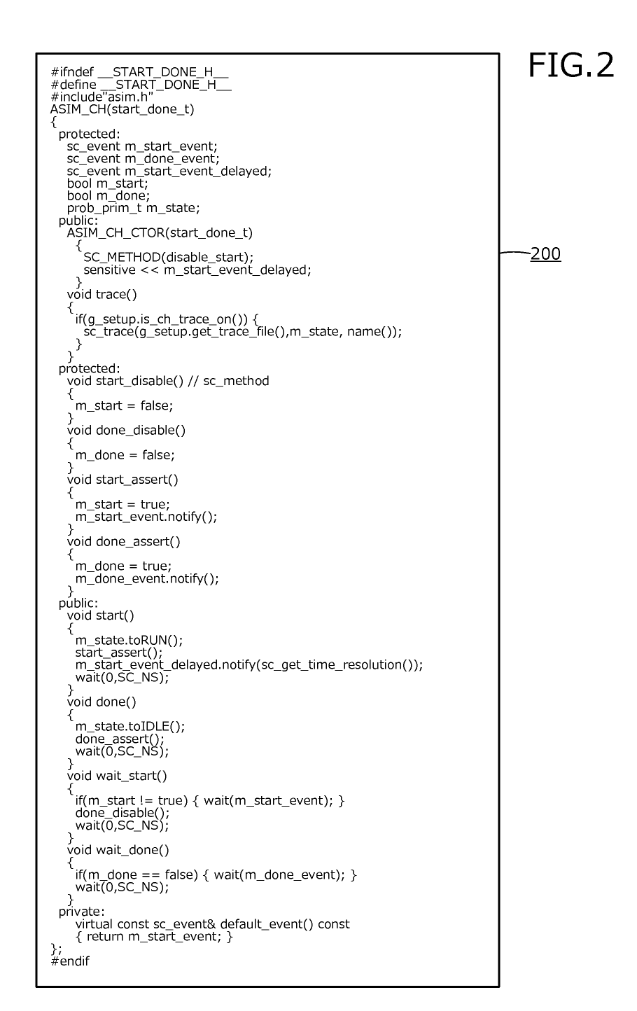

FIG. 2 is a diagram depicting an example of description of start_done. In FIG. 2, start_done description 200 is an example of description of a component for performing communication between the block (scenario block) that realizes the scenario and the block (calculation block) that performs calculations. The start_done description 200 enables communication to be realized between the scenario block and the calculation block. Further, the start_done description 200 can be used when relations are to be expressed of blocks that are desired to be modeled by invocation and termination protocols.

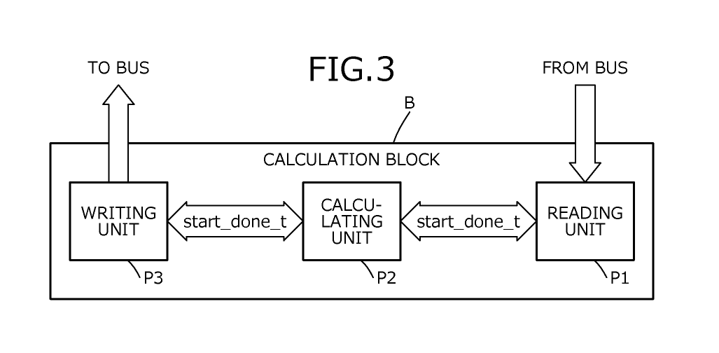

FIG. 3 is a diagram depicting an example of a calculation block. In FIG. 3, a calculation block B includes a reading unit P1, a calculating unit P2, and a writing unit P3. For the calculation count specified by the scenario block, the reading unit P1 reads the data size specified by the scenario block, and for each calculation, invokes the calculating unit P2.

The calculating unit P2 sends the data to the writing unit P3 after a delay period specified by the scenario block elapses. The writing unit P3 transmits the data of the data size specified by the scenario block. The reading unit P1, the calculating unit P2, and the writing unit P3, respectively are connected according to a start_done protocol (for example, refer to FIG. 2).

Further, if the calculating unit P2 is DONE, the reading unit P1 reads data and invokes the calculating unit P2. The calculating unit P2 is a model that STARTs the writing unit P3 and when the writing unit P3 is DONE, also sets itself to DONE. As a result, drops in processing performance consequent to bus congestion can be reproduced.

Further, the reading unit P1 receives a start_done_t signal that is from the scenario block and after reading for the calculation count specified by the scenario block, appends a last invocation flag to an invocation signal, and sends the invocation signal to the calculating unit P2. In this case, when invoking the writing unit P3, the calculating unit P2 appends a last invocation flag to an invocation signal and sends the invocation signal; the writing unit P3 returns DONE (end signal) to the scenario block. As a result, concerning the delay of the calculating unit P2, delay that takes into consideration delay caused by bus contention can be calculated.

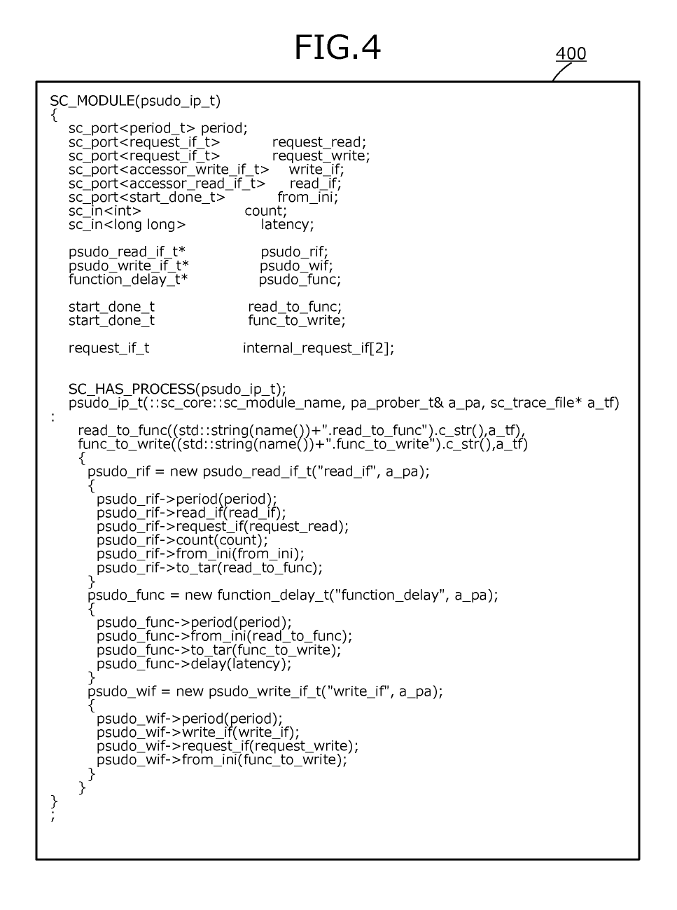

FIG. 4 is a diagram depicting an example of description of a calculation block. In FIG. 4, calculation block description 400 is an example of description for realizing operation of the calculation block B (refer to FIG. 3). The developer creates a block model such as the calculation block description 400 and registers the block model into a database (DB), thereby enabling the calculation block description 400 to be reused when simulation is performed.

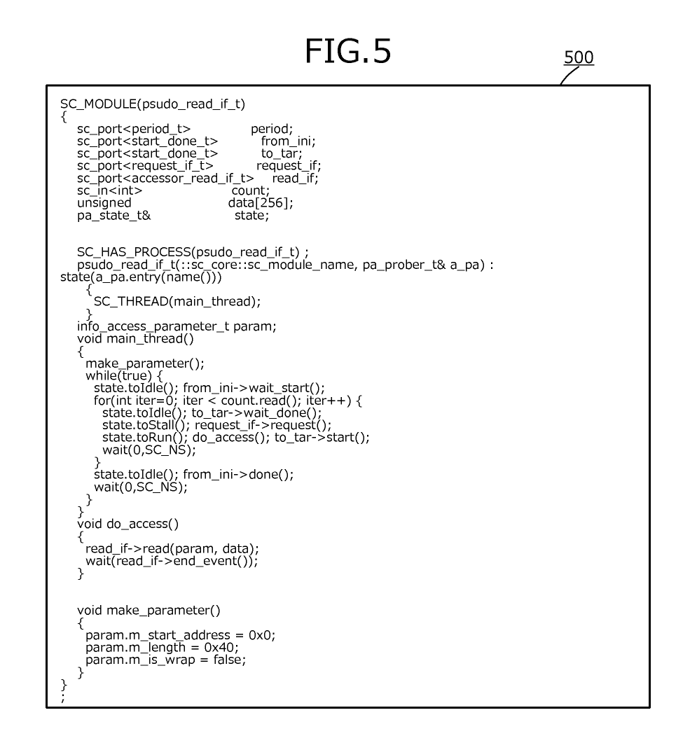

FIG. 5 is a diagram depicting an example of description of a read interface. In FIG. 5, read interface description 500 is an example of description for the read interface of the initiator (for example, the calculation block B). The developer creates an interface model such as the read interface description 500 and registers the interface model in the DB, thereby enabling the read interface description 500 to be reused when performing simulation.

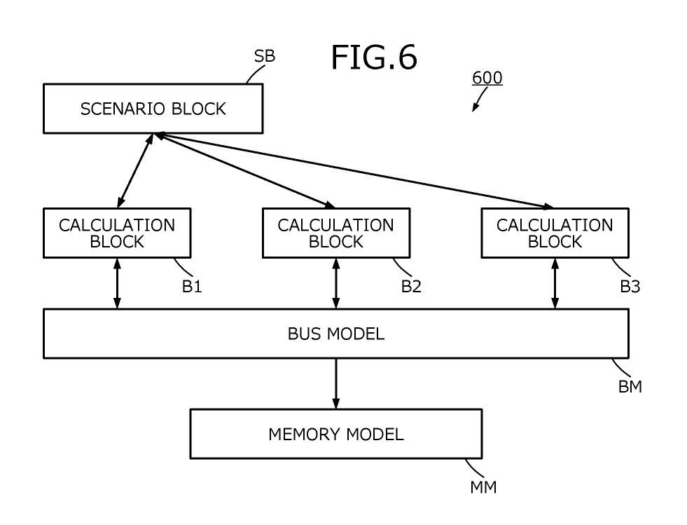

FIG. 6 is a diagram depicting an example of an architecture model. In FIG. 6, an architecture model 600 includes a scenario block SB, a calculation block B1, a calculation block B2, a calculation block B3, a bus model BM, and memory model MM. In the architecture model 600, the calculation blocks B of the calculation blocks B1 to B3 respectively communicate with the bus model BM.

The scenario block SB is a block that issues an invocation signal to the calculation blocks B1 to B3 and detects end signals from the calculation blocks B1 to B3. The scenario block SB, for example, corresponds to a central processing unit (CPU) that governs overall control of the architecture model 600.

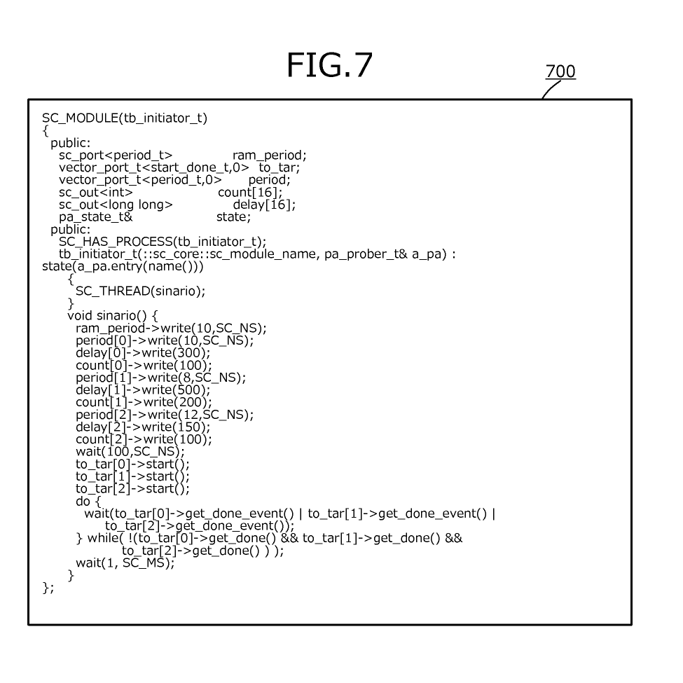

Further, based on a scenario (for example, scenario description 700 described hereinafter and depicted in FIG. 7, the scenario block SB sets various parameters in the calculation blocks B1 to B3. The various parameters, for example, are the count of calculations performed for one series of processes, the average calculation cycle count for one calculation, average read data volume for one calculation, average write data volume for one calculation, and the cycle described above.

The calculation blocks B1 to B3 are peripheral blocks that access the memory model MM via the bus model BM and perform calculations. More specifically, for example, the reading unit P1 (refer to FIG. 3) of the calculation block B1, upon receiving a start_done_t signal from the scenario block SB, reads data of a specified data size (for example, 50 bytes), for a specified calculation count (for example, 1000 times). The reading unit P1, upon completing one read process, sends an invocation signal to the calculating unit P2 (refer to FIG. 3).

More specifically, for example, the reading unit P1 calls a Read function (also specifying the data volume of the read data) of the bus model BM, and with the completion of the Read function, detects that the read process has ended and issues a DONE event. The Read function is ended after data has been written.

Upon receiving the invocation signal from the reading unit P1, the calculating unit P2, based on the operation frequency of the calculation block B, sends an invocation signal to the writing unit P3 (refer to FIG. 3) after the specified delay period elapses. For example, the specified delay period is assumed to be 100 cycles, and the operation frequency (cycle) of the calculation blocks B1 to B3 is assumed to be 1000 Hz. In this case, the calculating unit P2, upon receiving the invocation signal from the reading unit P1, sends an invocation signal to the writing unit P3 after 0.1 seconds(=100/1000) has elapsed.

The writing unit P3, upon receiving the invocation signal from the calculating unit P2, writes data of the specified data size (for example, 100 bytes). More specifically, for example, the writing unit P3 calls a Write function (also specifying the data volume) of the bus model BM, and with the completion of the Write function, detects that the write process has ended and issues a DONE event. The Write function is ended after the data is written.

The bus model BM connects the calculation blocks B1 to B3 and the memory model MM; and controls access to the memory model MM by the calculation blocks B1 to B3. More specifically, for example, the bus model BM has a bus function and a memory controller function (BUS+DRAM Interface). The memory model MM, for example, is a DRAM model.

More specifically, for example, the bus model BM, upon calling the Write function, writes data (for example, all-zero data) to the memory model MM, causes a delay equivalent to the size of the data (for example, 10 cycles), and ends the Write function. In other words, the bus model BM causes a delay by a blocking function call to end the function.

Here, an example of scenario description of the scenario block SB will be described taking a scenario in which the scenario block SB invokes the calculation blocks B1 to B3 concurrently, and ends the simulation after all of the processing of the calculation blocks B1 to B3 has ended, as an example.

FIG. 7 is a diagram depicting an example of scenario description of the scenario block SB. In FIG. 7, the scenario description 700 is a scenario that invokes the calculation blocks B1, B2, and B3 (in FIG. 7, 0, 1, and 2) concurrently, and ends the simulation after all of the processing of the calculation blocks B1 to B3 has ended.

More specifically, for example, in the scenario description 700, the calculation blocks B1 to B3 are set, and the count of calculations performed for one series of processes, the average calculation cycle count for one calculation, average read data volume for one calculation, average write data volume for one calculation, and the cycle are described. The scenario block SB and the calculation blocks B1 to B3 have signal lines PERIOD, DELAY, and COUNT that send parameters.

The PERIOD is the operation frequency of the calculation blocks B1 to B3. The DELAY is the delay of the calculating units P2 of the calculation blocks B1 to B3. The COUNT is a count of the calculation processes of the calculation blocks B1 to B3, i.e., a read count of the reading units P1 of the calculation blocks B1 to B3.

According to the scenario description 700, the scenario block SB sets various parameters in the calculation blocks B1 to B3, concurrently issues an invocation signal to the calculation blocks B1 to B3, and awaits detection of an end signal from each of the calculation blocks B1 to B3 (do-while statement).

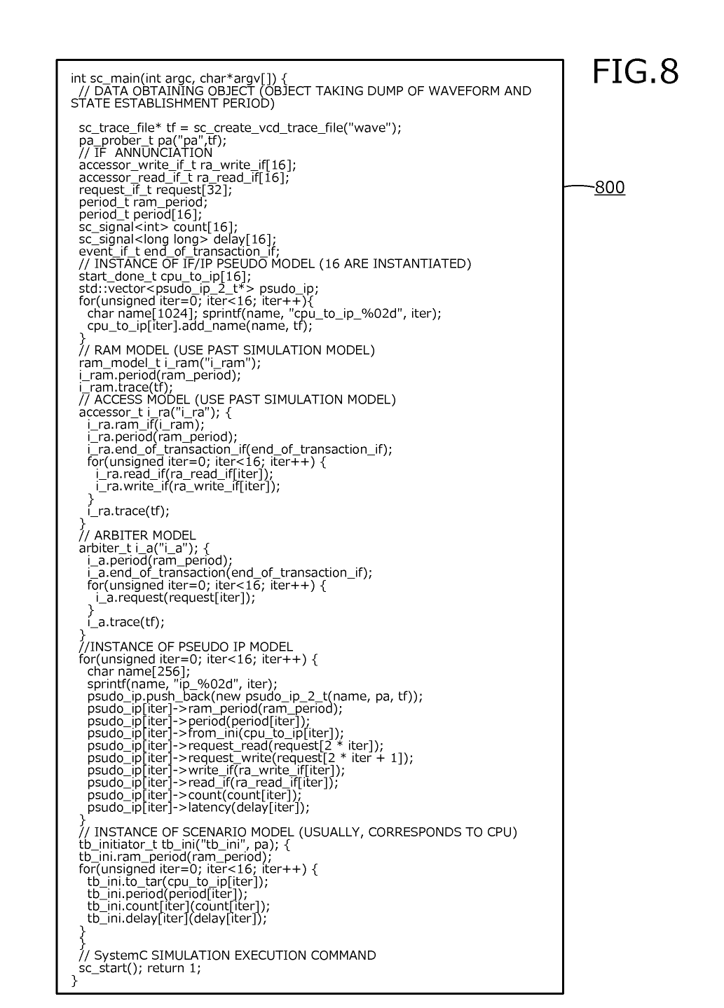

FIG. 8 is a diagram depicting an example of linking description. In FIG. 8, linking description 800 is architecture simulation description representing a model of linking between blocks such as those depicted in FIG. 6. Here, the calculation blocks B1 to B3 are defined having sufficient accuracy in reproducing bus contention, and by determining the method of communication with the scenario block SB, the entire linked network is compact, enabling a reduction in man-hours and simplification of the description as with the linking description 800.

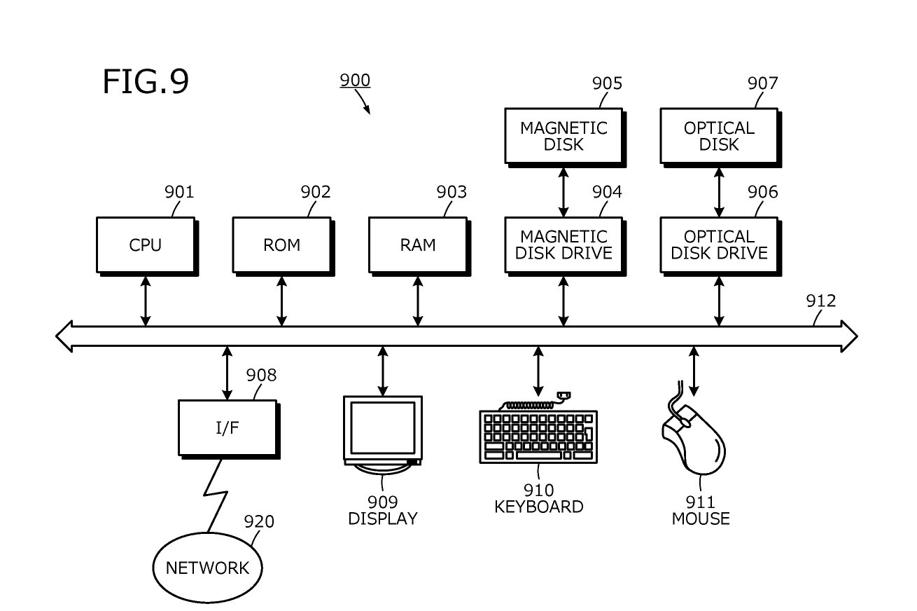

An example of a hardware configuration of a simulation apparatus 900 according to the embodiment will be described. FIG. 9 is a block diagram of an example of a hardware configuration of the simulation apparatus 900. In FIG. 9, the simulation apparatus 900 includes a CPU 901, read-only memory (ROM) 902, random access memory (RAM) 903, a magnetic disk drive 904, a magnetic disk 905, an optical disk drive 906, an optical disk 907, an interface (I/F) 908, a display 909, a keyboard 910, and a mouse 911, respectively connected by a bus 912.

The CPU 901 governs overall control of the simulation apparatus 900. The ROM 902 stores programs such as a boot program. The RAM 903 is used a work area of the CPU 901. The magnetic disk drive 904, under the control of the CPU 901, controls the reading and writing of data with respect to the magnetic disk 905. The magnetic disk 905 stores the data written thereto under the control of the magnetic disk drive 904.

The optical disk drive 906, under the control of the CPU 901, controls the reading and writing of data with respect to the optical disk 907. The optical disk 907 stores the data written thereto under the control of the optical disk drive 906, the data being read out by a computer.

The I/F 908 is connected through a communications line to a network 920 such as a local area network (LAN), a wide area network (WAN), and the Internet; and is connected to other apparatuses through the network 920. The I/F 908 manages an interface between the network 920 and components of the simulation apparatus 900, and controls the input and output of data with respect to external apparatuses. The I/F 908, for example, may be a modem, a LAN adapter, and the like.

The display 909 displays data such as documents, images, and functional information in addition to a cursor, icons, and toolboxes. The display 909, for example, may be a CRT, a TFT liquid crystal display, a plasma display, and the like.

The keyboard 910 has keys for inputting text, numerals, various instructions, etc., and performs the input of data. Further, a touch-panel-type input pad, a keypad, and the like may be employed. The mouse 911 moves the cursor, selects a range, moves and changes the size of windows, etc. A trackball or a joystick may be employed provided a function identical to that of a pointing device is provided.

Configuration may be such that among the components above, the simulation apparatus 900, for example, may omit the optical disk drive 906 and the optical disk 907. Further, in addition to the components above, the simulation apparatus 900 may further include, for example, a scanner and/or a printer.

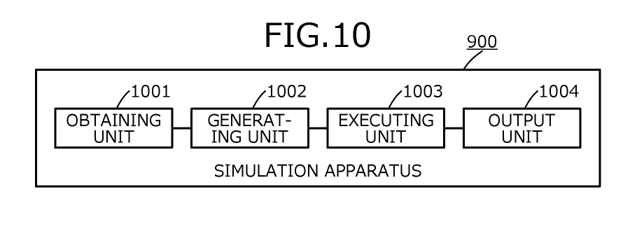

FIG. 10 is a block diagram depicting an example of a functional configuration of the simulation apparatus 900. In FIG. 10, the simulation apparatus 900 includes an obtaining unit 1001, a generating unit 1002, an executing unit 1003, and an output unit 1004. The obtaining unit 1001 to the output unit 1004 are functions forming a control unit and more specifically, for example, programs stored in a storage apparatus such as the ROM 902, the RAM 903, the magnetic disk 905, and the optical disk 907 depicted in FIG. 9 are executed by the CPU 901 or through the I/F 908, whereby the functions are implemented. Further, processing results of the functional units, for example, are stored to a storage apparatus such as the RAM 903, the magnetic disk 905, and the optical disk 907.

The obtaining unit 1001 has a function of obtaining an architecture model of the system to be evaluated. Here, the architecture model includes the scenario block SB, the calculation block B in plural (for example, the calculation blocks B1 to B3 above), the bus model BM, and the memory model MM.

The scenario block SB issues an invocation signal to the calculation blocks B and detects end signals from the calculation blocks B. The bus model BM connects the calculation blocks B and the memory model MM, and controls access to the memory model MM by the calculation blocks B. The calculation block B accesses the memory model MM via the bus model BM and performs calculation processes.

More specifically, for example, the architecture model, for example, includes peripheral block description and architecture simulation description. The peripheral block description is description information of the calculation blocks B included in the system subject to evaluation. The peripheral block description, for example, includes the calculation block description 400 depicted in FIG. 4 and the read interface description 500 depicted in FIG. 5.

Further, the developer creates the peripheral block description, for example, by reusing or combining block models and interface models registered in the DB. If the peripheral block description cannot be created from the DB, the developer describes the peripheral block description from scratch.

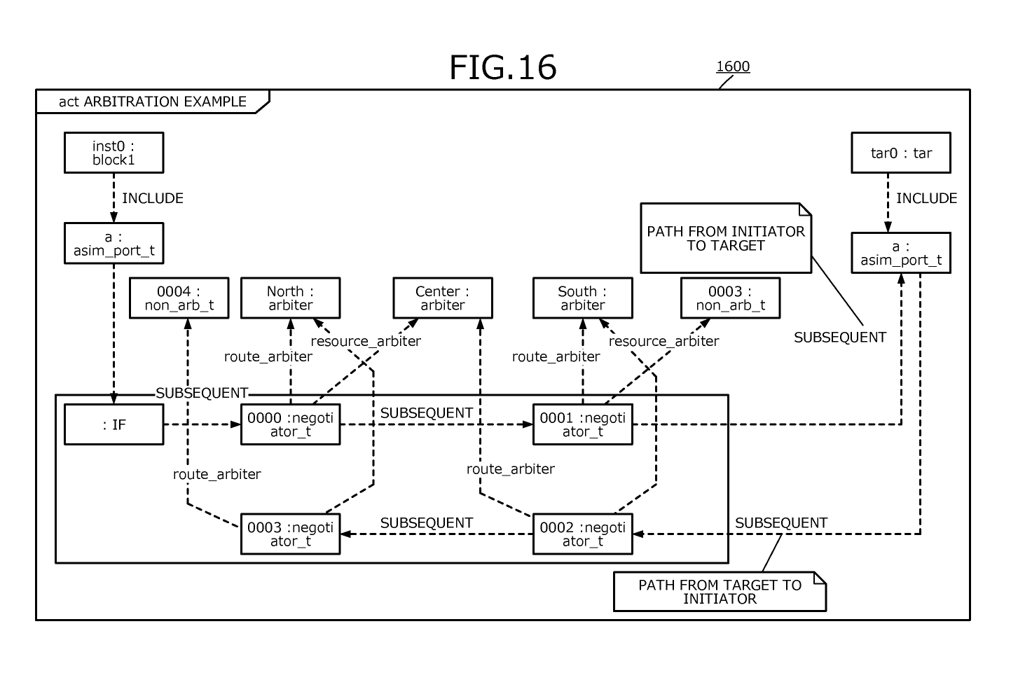

The architecture simulation description, for example, includes the start_done description 200 depicted in FIG. 2, the linking description 800 depicted in FIG. 8, and an arbitration model 1600 depicted in FIG. 16 and described hereinafter. The linking description 800 may be replaced by linking description connecting an initiator and a target by a route_n_{—}1_t, depicted in FIGS. 22 to 24 and described hereinafter.

Further, the obtaining unit 1001 has a function of obtaining scenario description of the system subject to evaluation. The scenario description is information indicating for each of the calculation blocks B, a count of the calculation processes performed by one series of processes, a cycle count for calculation processing, a read data volume for calculation processing, a write data volume for calculation processing, and an operation frequency of the calculation block B. The scenario description, for example, is the scenario description 700 depicted in FIG. 7.

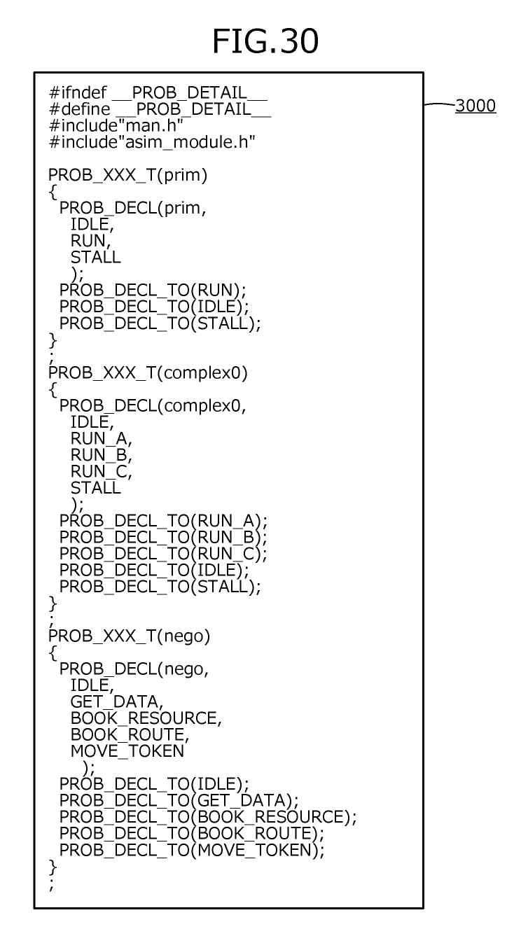

Further, the obtaining unit 1001 has a function of obtaining prober description of the system to be evaluated. The prober description, for example, is information that specifies a state for dumping a state value dependent on the specifications of the calculation block B. The prober description, for example, is prober description 3000 depicted in FIG. 30 and described hereinafter.

The generating unit 1002 has a function of generating an execution file of a simulation that evaluates system performance. More specifically, for example, the generating unit 1002 generates the execution file (binary) of the simulation, based on the obtained peripheral block description, the prober description, the architecture simulation description, and the scenario description.

More specifically, for example, the generating unit 1002 generates the execution file of the simulation by ASimLibrary together with compiling the peripheral block description, the prober description, the architecture simulation description, and the scenario description. The ASimLibrary describes expansion function of SystemC.

The executing unit 1003 has a function of executing the execution file generated for the simulation. When the execution file is executed, simulation is performed and execution results of the simulation are obtained. The execution results of the simulation, for example, include wiring data, measurement configuration data, and measurement data.

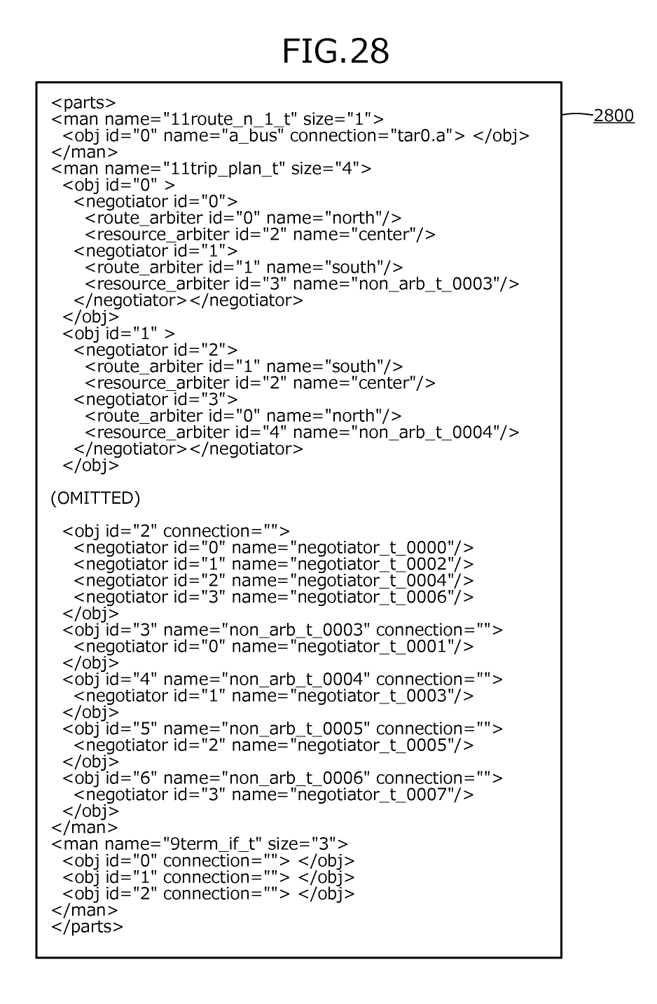

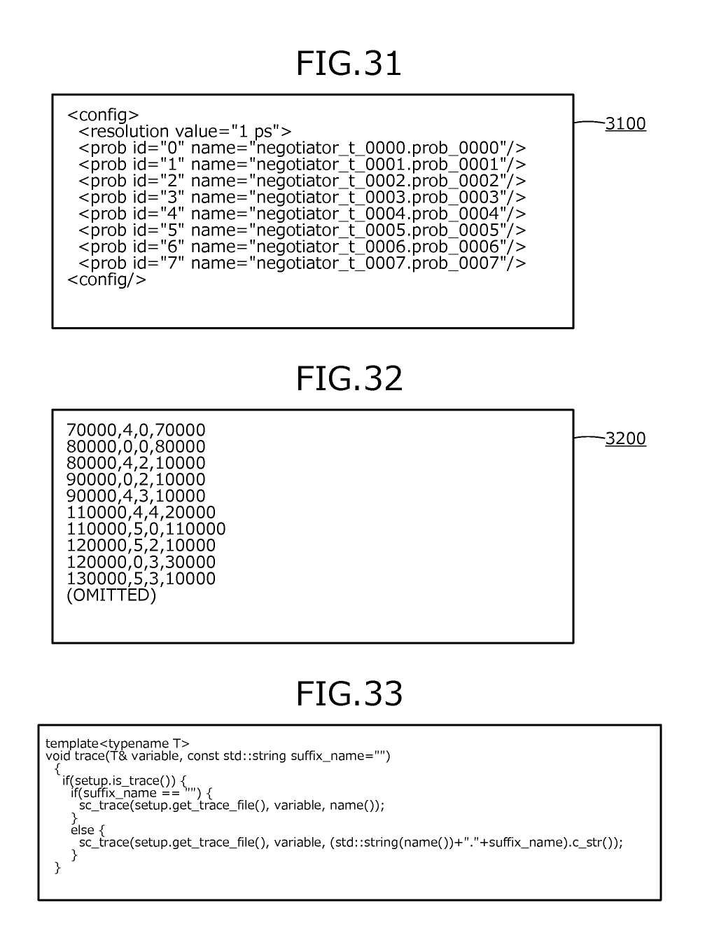

The wiring data is data indicating wiring relations of components. The wiring data is computer-readable information set as architecture information passed to another tool. For example, the wiring data is component information 2800 (parts.xml) depicted in FIG. 28 and described hereinafter. The measurement configuration data is data that indicates relations of ID numbers of measurement data and the subject of measurement. For example, the measurement configuration data is a configuration information list 3100 (conf.xml) depicted in FIG. 31 and described hereinafter. The measurement data is data describing measurement results such as a history of state change. For example, the measurement data is prober information 3200 (probe.csv) depicted in FIG. 32 and described hereinafter.

The output unit 1004 outputs execution results of the simulation. Forms of output by the output unit 1004, for example, include storage to a storage apparatus such as the RAM 903, the magnetic disk 905, and the optical disk 907, transmission to an external apparatus via the I/F 908, and display on the display 909.

Here, an example of simulation of the architecture model 600 (refer to FIG. 6), based on the scenario description 700 will be described.

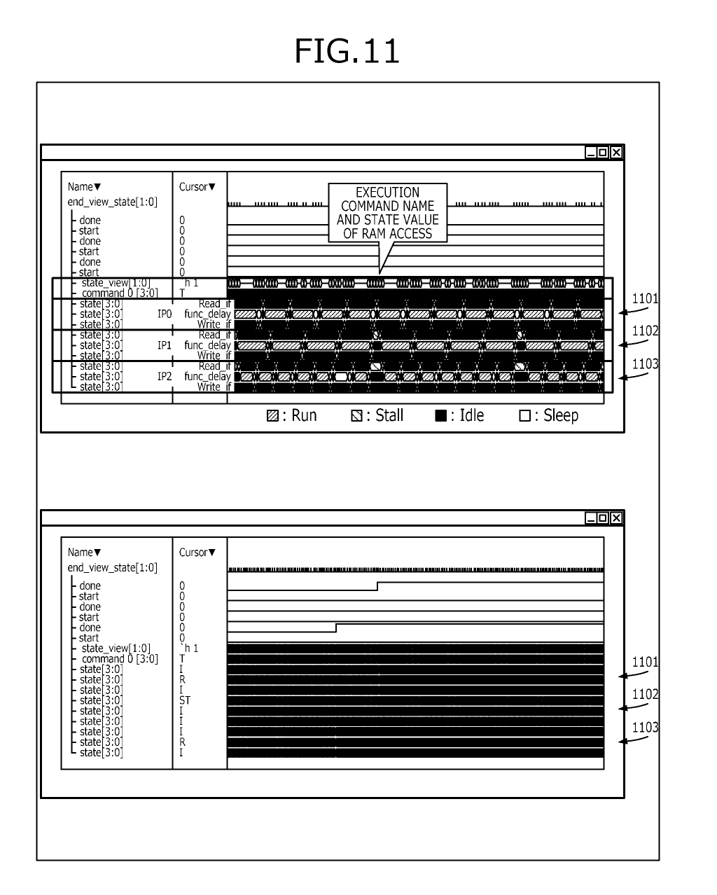

FIG. 11 is a diagram depicting an example of execution of simulation. In FIG. 11, graphs 1101, 1102, and 1103 are graphs depicting execution state of the calculation blocks B1, B2, and B3 (in FIG. 11, IP0, IP1, and IP2). In FIG. 11, R represents a run state, ST represents a stalled state, I represents an idle state, and SL represents a sleep state.

From the graphs 1101 to 1103, a stalled state of the calculation blocks B1, B2, and B3 is indicated, and it is known that bus contention has been reproduced. Further, it is known that the calculation blocks B1, B2, and B3 have finished the processing of the specified count and that join of DONE has been set and finished.

In the description above, although a case has been described where an existing model is used as the bus model BM, there are various types of buses and cost is required in preparing a bus model that corresponds to each type. Thus, in the description hereinafter, bus universal utility will be described.

Bus protocol will be described. In the bus protocol, a process called “data dispatch” is defined. Data dispatch is a process of transferring data. Write access is modeled by “data dispatch”. Further, read access is modeled by data dispatch of a “data order sheet” and data dispatch of “ordered data”. In other words, read access is interpreted as a series of processes of issuing a “data order sheet” to a target and the target performing the “ordered data dispatch”.

More specifically, for example, upon receiving from the calculation block B, a transfer request for data of a write data volume set by the calculation block B, the bus model BM writes the data of the write data volume to the memory model MM.

Further, upon receiving from the calculation block B, a transfer request for a data order sheet, the bus model BM writes the data order sheet to the memory model MM. In data order sheet, a read data volume set by the calculation block B is indicated. When the data order sheet is written by the bus model BM, the memory model MM writes to the bus model BM, data of the read data volume indicated in the data order sheet. When data of the read data volume is written by the memory model MM, the bus model BM transmits to the calculation block B, the written data of the read data volume.

Hereinafter, an example of the bus protocol of the bus model BM will be described. Although bus a model is written, a bus based on these specifications may be used in the actual design. The bus protocol discussed hereinafter, has a simple single line configuration formed by a Pack_signal line and a Contents_signal line, and a mechanism that extracts control information (address value, etc.) by partial data interpretation; and greatly differs from a typical on-chip bus that distinguishes addresses lines and data lines. Therefore, in a case of an application for which such qualities are suitable or in a case where simplification is desirable for automatic circuit generation, this bus model can be used as a circuit. Therefore, the bus model may be thought to be, in a broad sense, a bus model that includes a bus circuit used for design.

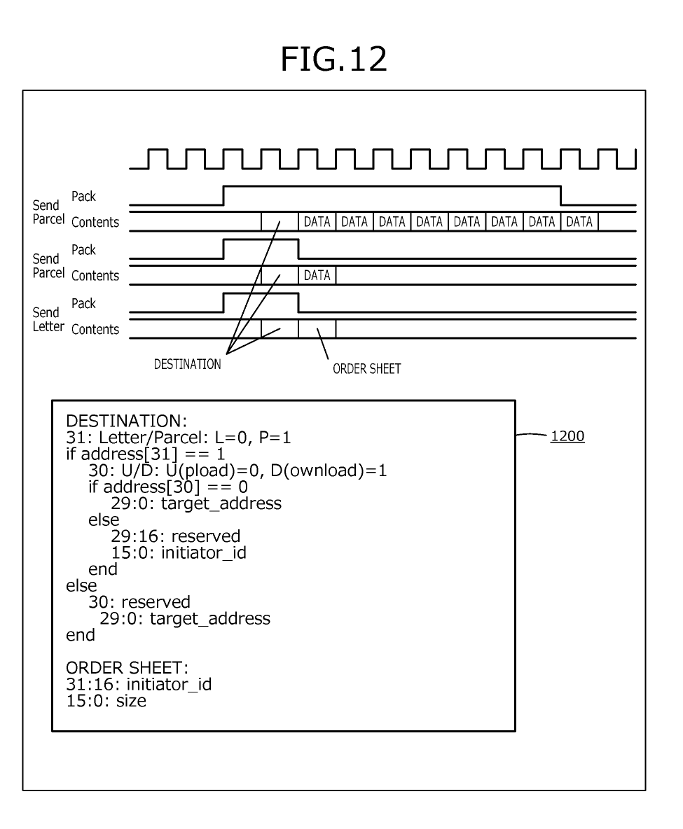

FIG. 12 is a diagram (part 1) depicting an example of the bus protocol. In FIG. 12, bus protocol 1200 defines the meaning of data bits. DESTINATION is 32-bit data. The highest bit of DESTINATION, i.e., the 31st bit indicates whether the type of transfer is Letter_format (written communication format) or Parcel_format (small package format).

The Letter_format is a type of transfer for sending an order sheet. The Parcel_format is a type of transfer for sending actual data. The highest bit of the Letter_format is “0” and the highest bit of the Parcel_format is “1”.

Further, when the value of the highest bit is “1 (Parcel_format)”, 30th bit represents upload “0” or download “1”. When the value of the 30th is “0 (upload)”, the 29th to the 0th bits are interpreted as the address of the destination. On the other hand, when the value of the 30 is “1 (download)”, the 29th to 16th bits are reserved (for example, set with 0) and the value of this portion is not interpreted. The 15th to the 0th bits store the ID number of the initiator.

When the value of the highest bit is “0 (Letter_format)”, the 30th bit is reserved and not used. Further, the 29th to the 0th bits are the address (target address) of the destination.

The order sheet is 1-word (32 bits) data in which the upper 2 bytes are the ID number of the initiator that sends and returns data and the lower 2 bytes are the size of the data sent and returned. The target transfers data of the size indicated in an order sheet from the address specified by the target address.

The bus protocol 1200 enables a bus transaction, which is the basis of data transfer, to be defined. As a result, for the architecture model as well, if data transfer (write access) is similarly modeled, a desired bus transaction can be described. Further, by comparing the bus protocol 1200 and the actual bus protocol, performance approximation becomes possible.

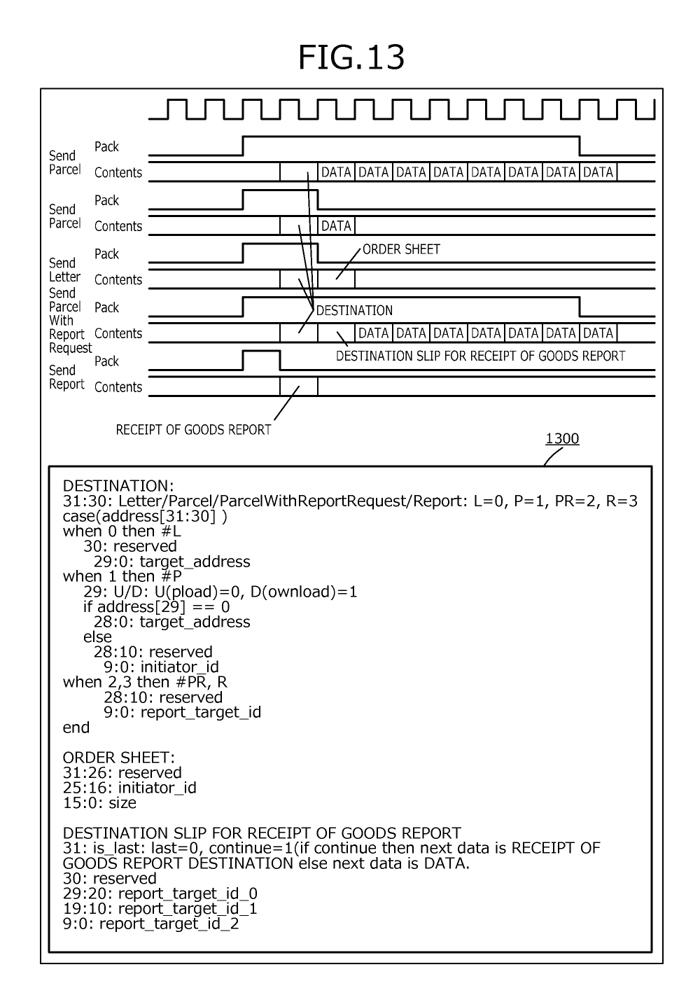

FIG. 13 is a diagram (part 2) depicting an example of bus protocol. In FIG. 13, bus protocol 1300 defines the meaning of data bits. DESTINATION is 32-bit data. The 31st to the 30th bits of DESTINATION indicate the type of transfer.

Types of transfer include 4 types: Letter_format, Parcel_format, Parcel With Report Request_format, and Report_format, to which values of 0, 1, 2, and 3 are assigned. Further, in the case of 3, DESTINATION is called a receipt of goods report.

When the values of the 31st to the 30th bit are “0 (Letter_format)”, the 30th bit is reserved and the value of this portion is not interpreted. Further, the 29th to the 0th bits are the address (target address) of the destination.

When the value of the 31st to the 30th bits are “1 (Parcel_format)”, the 29th bit represents upload “0” or download “1”. When the value of the 29th bit is “0 (upload)”, the 28th bit to the 0th bit are the address (target address) of the destination. On the other hand, when the value of the 29th bit is “1 (download)”, the 28th to the 10th bits are reserved and the values of this portion are not interpreted. The 9th to the 0th bits store the ID number of the initiator.

When the values of the 31st to the 30th bits are “2 (Parcel With Report Request_format)” or “3 (Report_format)”, the 28th to the 10th bits are reserved and the values of this portion are not interpreted. In the 9th to the 0th bits, the ID number of the destination of the report is written.

In the order sheet, the 31st to the 26th bits are reserved; the 25th to the 16th bits are the ID number of the initiator that sends and returns the data; and the 15th to the 0th bits are the size of the data sent and returned.

In a destination slip for the receipt of goods report the 31st bit indicates whether the subsequent data cell is data or the destination slip for the receipt of goods report continues. In the case of “0”, the destination slip for the receipt of goods report continues, while in the case of “1”, the destination slip for the receipt of goods report ends and data continues subsequently. In the 29th to the 0th bits, three receipt of goods report destination of 10 bits each can be written. “0” is not used and if “0” is written, the bits are regarded as an invalid ID number and ignored.

The bus protocol 1300 enables notification that a small package (data) has arrived, to be transmitted to another initiator and enables application in a case where control occurs consequent to data migration. In FIGS. 12 and 13, although an example has been described in which the width of the content line is 32 bits, when the width of the content line is 16 bits, the DESTINATION is regarded as two words, where two words are used per one data.

Arbitration will be described. Arbitration is a circuit that performs arbitration such that plural calculation blocks do not occupy the bus. Here, arbitration (Route Arbitration) that controls the exclusivity of a transfer path and arbitration (Resource Arbitration) that controls the exclusivity of a resource are used.

Further, deciding whether exclusive right to a resource of a goal is to be taken may be necessary. As an arbitration strategy in this case, for example, after negotiation of the goal is performed, there are patterns that respectively start transfer, advance local negotiation, and approach the goal. In cases where arbitration is not necessary, arbitration is not performed by non-arbitration.

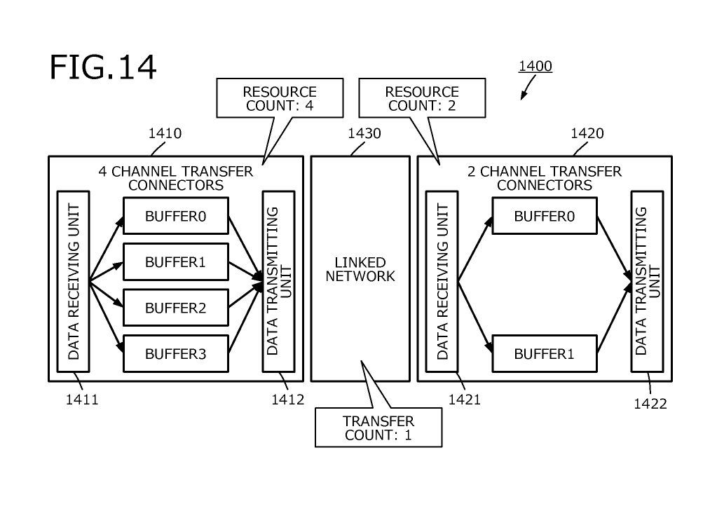

FIG. 14 is a diagram depicting an example of an arbitration circuit. In FIG. 14, a transfer mechanism 1400 is a circuit realized by Route Arbitration and Resource Arbitration. The transfer mechanism 1400 has four channel transfer connectors 1410 and two channel transfer connectors 1420. The four channel transfer connectors 1410 and the two channel transfer connectors 1420 are linked by a linking network 1430.

The four channel transfer connectors 1410 have a data receiving unit 1411, a data transmitting unit 1412, and buffers 0 to 3. The two channel transfer connectors 1420 have a data receiving unit 1421, a data transmitting unit 1422, and buffers 0 and 1. The linking network 1430 is the subject of Route Arbitration. The buffers 0 to 3 and the buffers 0 and 1 are the subject of Resource Arbitration.

Trip plan will be described. A trip plan is a negotiation list and represents a route to a destination (for example, a target).

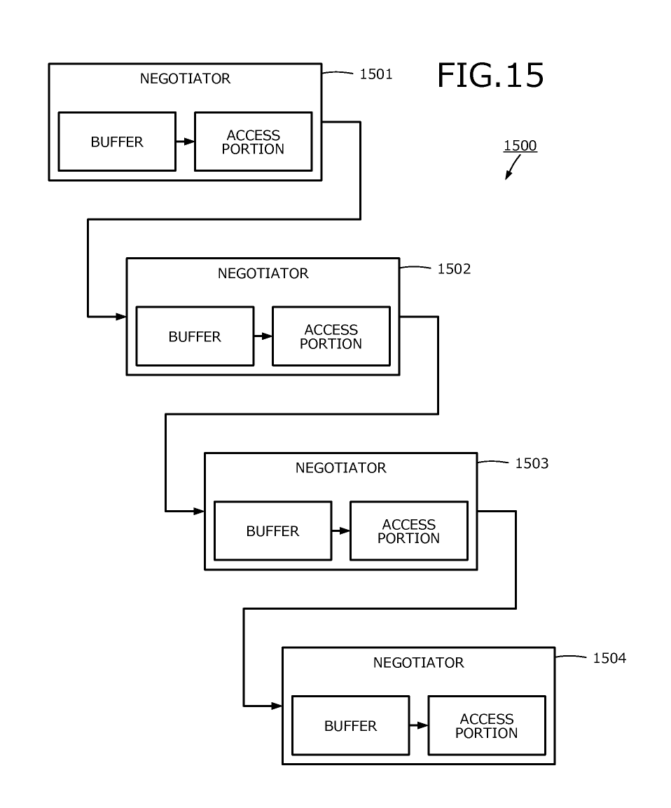

FIG. 15 is a diagram depicting an example of a circuit of a trip plan. In FIG. 15, a trip plan 1500 has negotiators 1501 to 1504. The negotiators 1501 to 1504 each have a buffer and an access portion.

A parcel (data of Parcel_format) and written correspondence (data of Letter_format) use the buffers of the negotiators 1501 to 1504 while being transferred to the destination. The access portion of the negotiators 1501 to 1504 is a portion that negotiates with an arbiter whether to perform migration to the subsequent encampment (for example, the buffer of the subsequent negotiator). If the arbiter grants permission, the parcel/the written correspondence migrate to the subsequent encampment.

FIG. 16 is a diagram depicting an example of an arbitration model. In FIG. 16, in the arbitration model 1600, the migration of the parcel/the written correspondence between the negotiators is realized by the negotiator of the migration source making a reservation with the arbiter (resource_arbiter) to which the negotiator of the migration destination belongs.

More specifically, the arbiter (resource_arbiter) manages the resource count and if a resource is available, grants permission to the negotiator of the migration source. On the other hand, if no resource is available, the arbiter (resource_arbiter) defers the negotiator and when a resource becomes available, grants permission to the negotiator of the migration source.

Further, the negotiator of the migration source can send the parcel/written correspondence if permission is granted by the arbiter (resource_arbiter) and therefore, establishes a transfer path. Establishment of the transfer path is realized by making a reservation with the arbiter (route_arbiter).

The negotiator of the migration source transfers the parcel/written correspondence after the transfer path is established. When the transfer of the parcel/written correspondence has ended, the buffer of the negotiator of the migration source becomes available and therefore, the negotiator of the migration source informs the arbiter, to which the negotiator of the migration source belongs, of checkout and releases the resource.

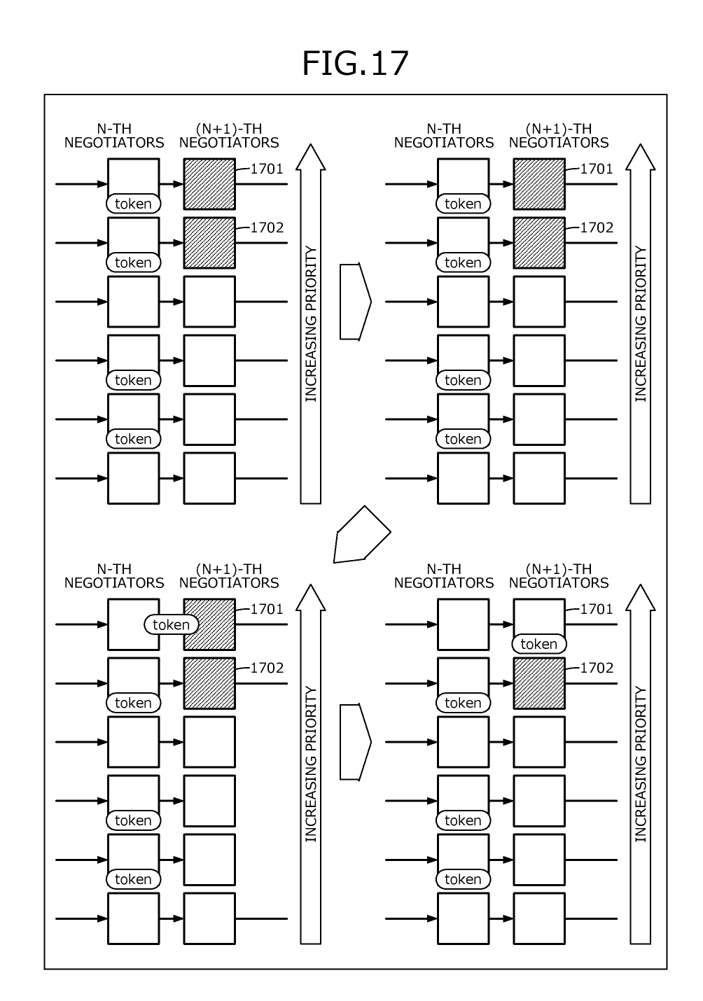

FIG. 17 is a diagram depicting an example of data transfer. FIG. 17 depicts an example in which a token (data) is transferred from the N-th negotiator to the (N+1)-th negotiator. The token, for example, is data that includes the type, the order sheet, a data byte count, transit-component history, etc.

In the example depicted in FIG. 17, transfer paths 1701 and 1702 secure resources by Resource Arbitration. Subsequently, the transfer path 1701 is selected by Route Arbitration.

As a result of the selection of the transfer path 1701, a token is migrated from the N-th negotiator to the (N+1)-th negotiator for a bus transfer period. More specifically, for example, after writing data to the (N+1)-th negotiator, N-th negotiator notifies the arbiter of the release of the transfer path 1701, after a given period elapses.

In this manner, the sending source (for example, the initiator) and the sending destination (for example, the target) are connected by the trip plan and as depicted in FIG. 16, by correlating the arbiter, operation of the bus can be simulated. Further, by connecting a non-arbitration class, that portion can perform a transfer without resource restriction. In other words, by modeling by a path called trip plan, simulation of exclusive control can be realized.

“route_n_{—}1_t” is defined as a secondary element summarizing the trip plan. A class diagram of a trip plan will be described.

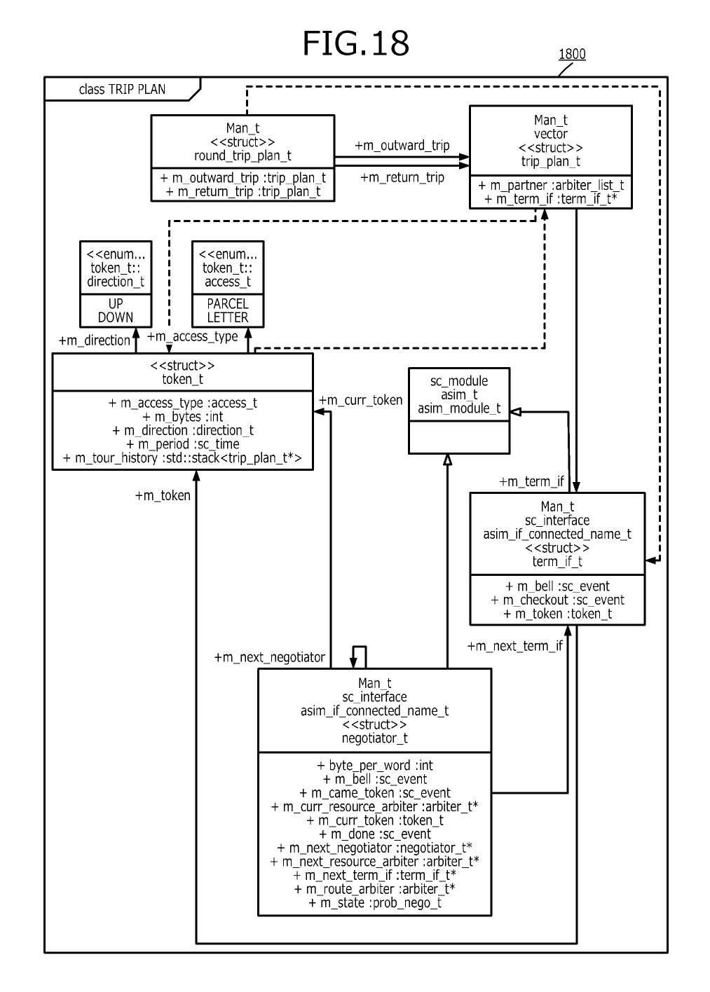

FIG. 18 is a diagram depicting an example of a class diagram of a trip plan. In FIG. 18, a class diagram 1800 is a class diagram of a trip plan. In the class diagram 1800, round_trip_plan_t for route_n_{—}1_t is defined. “round_trip_plan_t” encompasses trip plans for an outward path and a return path.

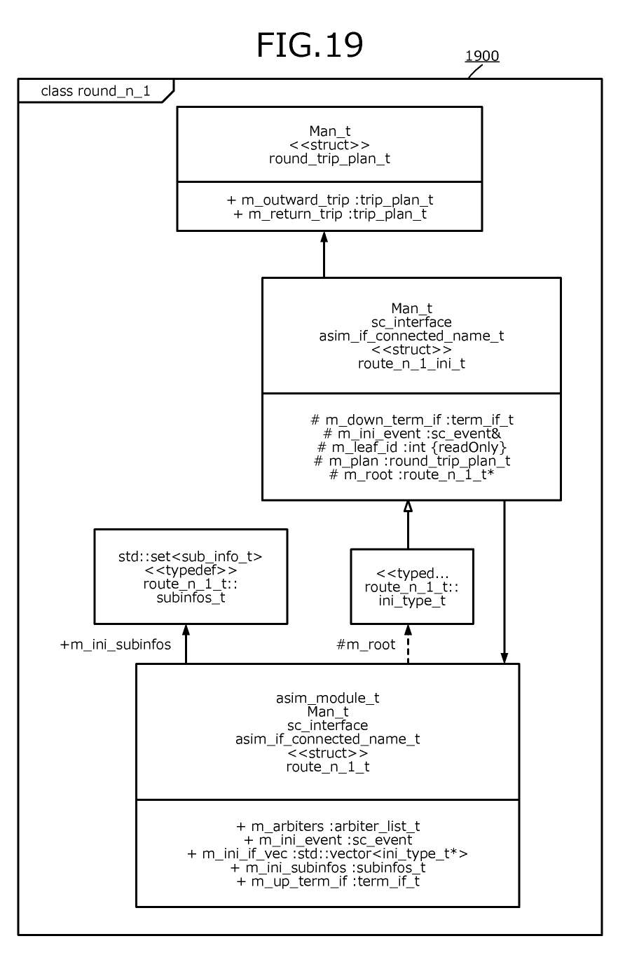

FIG. 19 is a diagram depicting an example of a class diagram of route_n_{—}1_t. In FIG. 19, a class diagram 1900 is a class diagram of route_n_{—}1_t. “route_n_{—}1_t” is a class that indicates a relation of n initiators related to one target. “route_n_{—}1_ini_t” is an interface for receiving access from an initiator.

Meanwhile, route_n_{—}1_t is also an interface of the target side. “route_n_{—}1_ini_t” has round_trip_plan_t. Therefore, the outward and return trip plans can be managed.

A flow of preprocessing of the simulation apparatus 900 will be described. The simulation apparatus 900 invokes a measurement data dump. Setting is such that when the measurement data dump is invoked, a file pointer for dump data is passed to an instantiated model and event history is output.

The simulation apparatus 900 sets the architecture consequent to user input using the keyboard 910 and/or the mouse 911 depicted in FIG. 9. Subsequently, the simulation apparatus 900 generates the set architecture.

Although the negotiator of the trip plan instantiates (#arbiter+1)/2, since arbiter setting is performed after the connection wiring, a phase is provided that automatically instantiates. Further, in the case of inheritance class of Man_t of a template class, virtual make( ) is called and therefore, it suffices that processing that is to be created at this phase be written in virtual make( ).

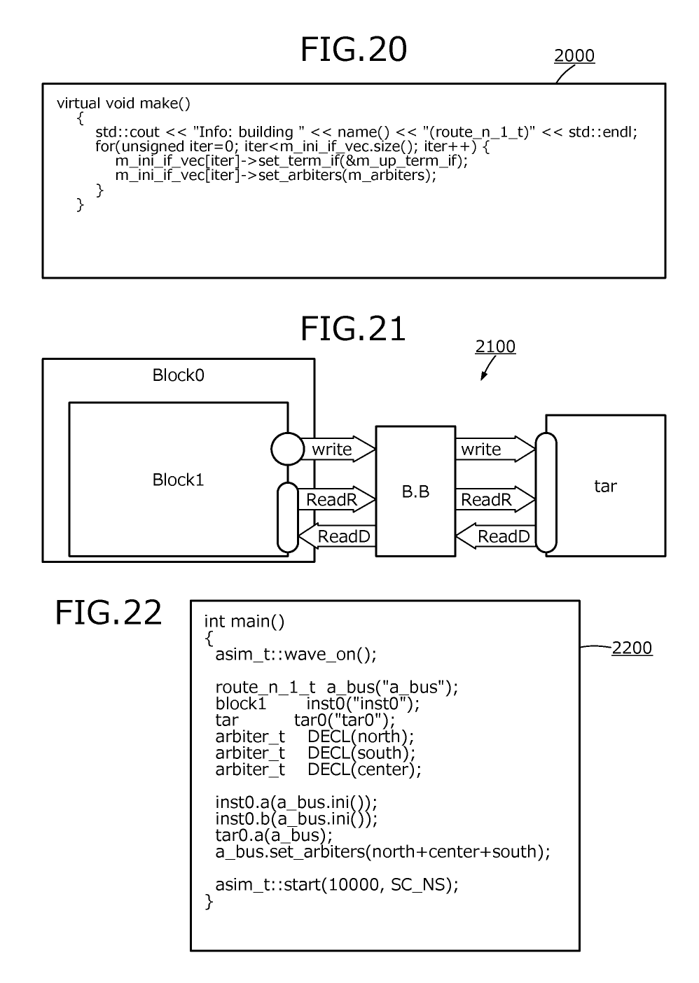

FIG. 20 is diagram of an example of a definition of make( ) of route_n_{—}1_t. In FIG. 20, definition 2000 is an example of a definition of make( ) of route_n_{—}1_t. In route_n_{—}1_t, each time ini( ) is called, although a route_n_{—}1_ini_t list and an arbiter list are finished, the trip plan is not completed. Thus, in the definition 2000, the trip plan is created. As a result, the degree of freedom of the setting of the architecture is increased, thereby improving description.

FIG. 21 is a diagram depicting a sample example of architecture. In FIG. 21, architecture 2100 includes Block0, Block1, B.B, and tar. Block1 has a write port and a read port. The write port transfers parcels. The read port transfers written correspondence. “tar” is a target; and upon receiving written correspondence, sends a parcel.

FIG. 22 is a diagram depicting an example of architecture connection description. In FIG. 22, top description 2200 is an example of connection description of the architecture 2100 depicted in FIG. 21. In the top description 2200, arbiter_t has three types: north, center, and south.

Connection passes a_bus.ini( ) to inst0.a. When a_bus.ini( ) is called, a single route_n_{—}1_ini_t is placed in a vector container of route_n_{—}1_ini_t in route_n_{—}1_t and this interface is passed to inst0.a; and similarly for inst0.b.

Subsequently, a_bus is passed to tar0.a and from the initiator side, north, center, and south are passed as an arbiter of a_bus. “north” is an arbiter of wiring between B.B and the initiator. “south” is an arbiter of wiring between B.B and the target. “center” is the arbiter of B.B. Further, at the time of annunciation, if numerals have been omitted, the resource count is 1.

“asim_t::wave_on( )” is “invocation of measurement data dump”. “asim_t::START” is a method of performing sc_START after “architecture generation”. Further, DECL expands DECL(north) into north(“north”) by a macro. Here, an example of peripheral circuit description will be described.

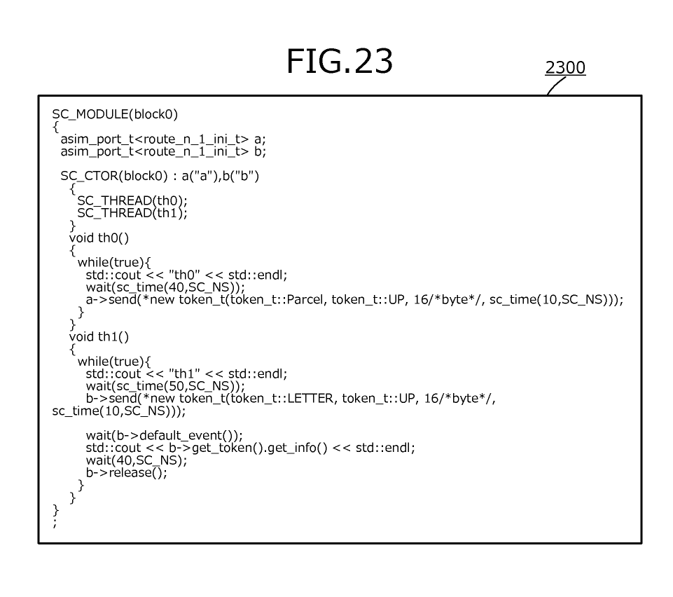

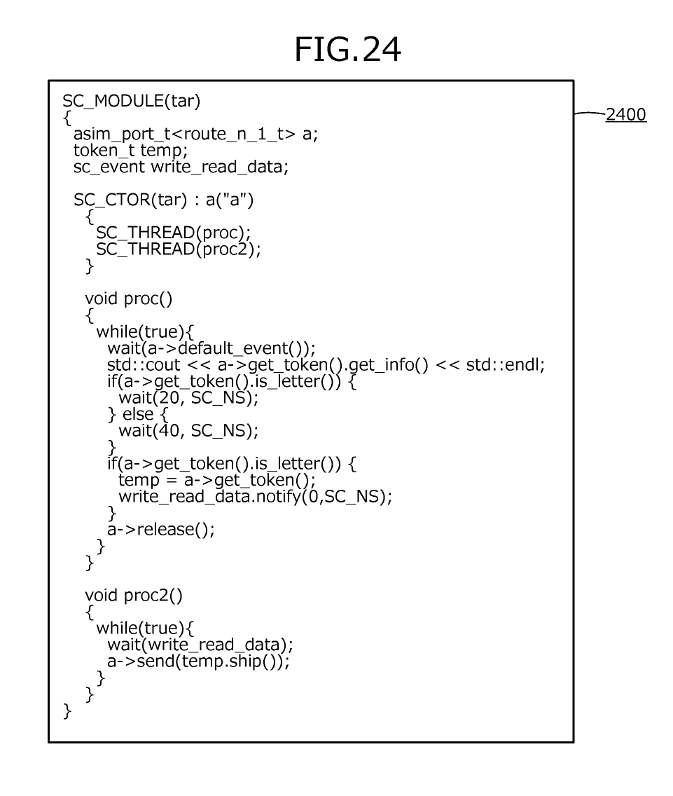

FIG. 23 is a diagram depicting an example of circuit description of an initiator. In FIG. 23, circuit description 2300 is an example of circuit description of a block that is an initiator. FIG. 24 is a diagram depicting an example of circuit description of a target. In FIG. 24, circuit description 2400 is an example of circuit description of a block that is a target.

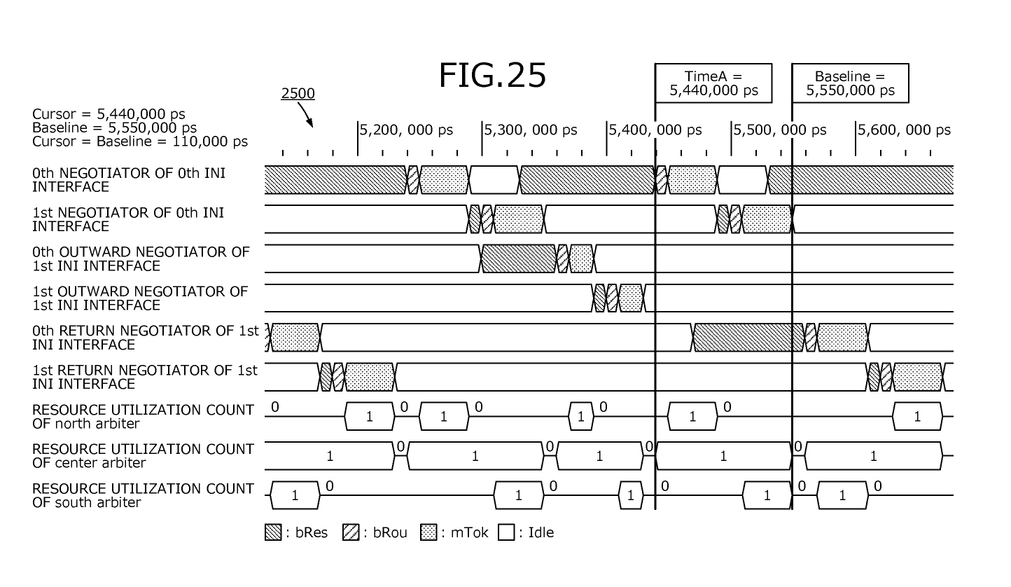

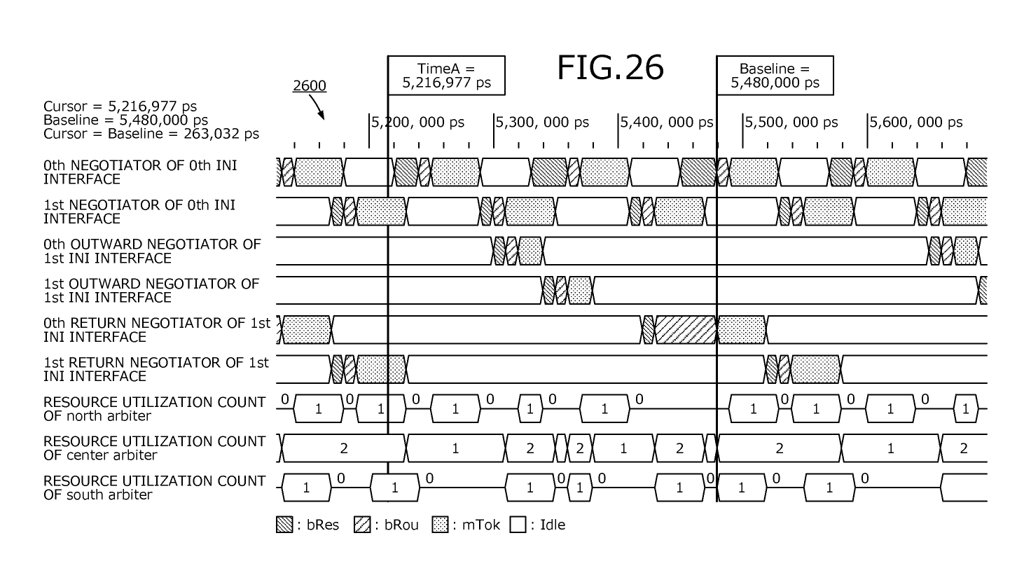

FIGS. 25 and 26 are diagrams depicting an example of state transition. In FIG. 25, graph 2500 depicts state transition of negotiators in a case where simulation is executed using the description examples depicted in FIGS. 22 to 24. In FIGS. 25 and 26, bRes represents bookResource (resource_arbiter); bRou represents bookRoute (route_arbiter); and mTok represents moveToken.

In graph 2500, for example, from cursor “TimeA” to “Baseline”, the center arbiter is occupied. Further, after writing to the buffer on B.B begins through wiring on the initiator side, data in the buffer on B.B is occupied until writing to the target is complete. Graph 2500 reveals that the center arbiter is congested.

Graph 2600 depicts state transition of the negotiators in a case where the center resource count is increased to 2. More specifically, DECL(center) is regarded as DECL_VA(center,2). In graph 2600, an initiator-issued parcel and written correspondence concurrently stop by the B.B portion, and it appears that the initiator-issued parcel and the target-issued parcel are interchanged; further it is known that bus operation can be simulated.

In this manner, by combining trip plan, bus operation can be written by relatively short description, enabling manufacturing to be improved. Further, an environment can be built that enables simulation of an event base modeling architecture, in particular, by tokens, transfer paths, arbitration, and resource counts that indicate events and transfer. Further, this means that the bus specified by the model is of a simple configuration, and that the bus model and a specified circuit can perform data transfer by simple control.

A method of realizing output of structure information (architecture information) will be described. Here, description will be given taking an example of a case where connection relations with architecture elements annunciated until asim_t::START of the top description 2200 depicted in FIG. 22.

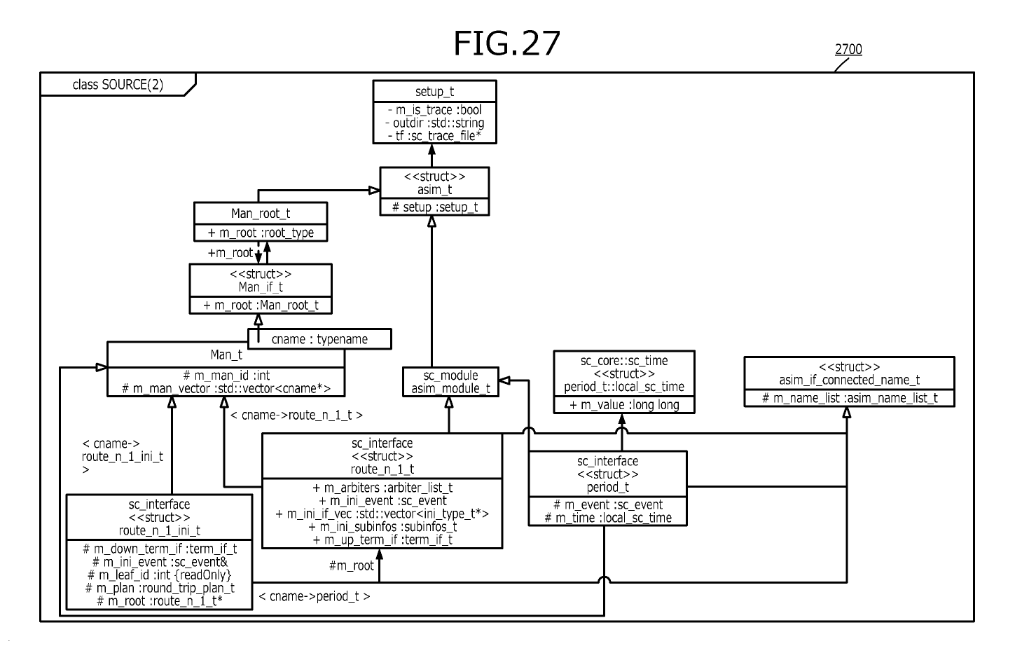

FIG. 27 is a class diagram related to structure information. In a class diagram 2700 depicted in FIG. 27, setup_t is a class having various types of settings; asim_t is a class having setup_t in a class variable and is used as a name space; and Man_root_t is a root class that manages management objects. Man_root_t, as a class variable, has a map referred to from a name subject to management (generated by typeid(cname) from cname described hereinafter) by Man_if_t.

Man_if_t has a pointer to Man_root_t as a class variable. Man_t is a management object of the class of cname and manages the pointer to cname. Further, Man_t, upon instantiation, registers Man_t<cname> to m_root. Man_t has a vector of the pointer to cname as a class variable.

“route_n_{—}1_ini_t” is an inheritance class of Man_t regarded as cname→route_n_{—}1_ini_t. When this class is instantiated, a pointer thereto is registered to m_man_vector of Man_t; and similarly for route_n_{—}1_t and period_t.

From Man_root_t::root_type, all Man_t can be searched. Furthermore, from Man_t<cname>, instances of all cname can be referred to. In this manner, the class diagram 2700 enables component information of main components to be output. Here, an example of output of component information will be described.

FIG. 28 is a diagram depicting an output example of component information. In FIG. 28, the component information 2800 is a definition under the simulation environment, output in a computer-readable format. The component information 2800, for example, can be used as debugging, a graphical user interface (GUI), and definition data for design.

A method of realizing an output of block information will be described.

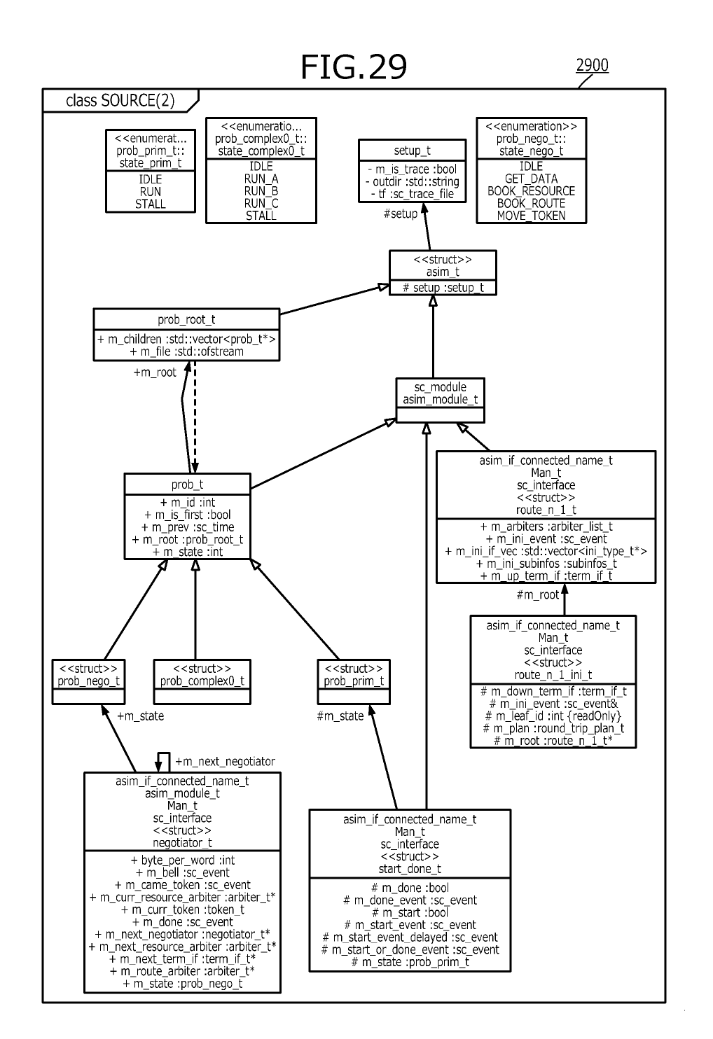

FIG. 29 is a class diagram related to block information. In a class diagram 2900 depicted in FIG. 29, prob_root_t has a vector of a pointer to prob_t; and prob_t has prob_root_t in a class variable. Further, prob_t registers itself in the class variable m_root.

“prob_xxx_t” (in FIG. 29, prob_nego_t,prob_complex0_t,prob_prim_t) is a class in which a specific state in which prob_t is formatted is defined. An object that visualizes a state instantiates prob_xxx_t.

The object, when a state transition occurs, calls a method called to<state name>( ) and changes the state of prob_xxx_t. “prob_xxx_t” writes this value (state) to a file. In this manner, the class diagram 2900 enables block information to be output.

Separation of prob_t and prob_xxx makes defining probers having differing states easier. Here, an example of defining a state will be described.

FIG. 30 is a diagram depicting an example of defining a state. In FIG. 30, the prober description 3000 is a state table. For example, states such as RUN, IDLE, and STALL are prepared in advance. On the other hand, in the case of states particular to an application such as a decode mode and an encode mode, the user defines the states. In FIG. 30, complex0 is an example of a user defined state.

By such definitions, PROB_XXX becomes a template class that corresponds to such functions and therefore, processing to generate the functions can be performed by a tool. To observe a state value defined by the prober, description may be added such that at the timing at which the state changed in peripheral block description, the state value is dropped. For example, state.XXXX is description corresponding to this. Further, configuration is such that bus related data (data flow volume, etc.) is dropped from among bus components. Here, with reference to FIGS. 31 and 32, an example of output in a case where the prober description 3000 is executed.

FIG. 31 is a diagram depicting an example of configuration information. In FIG. 31, when the prober description 3000 is executed, the configuration information list 3100 is a list of ID numbers output at the stage when asim_t::START( ) is called.

In the configuration information list 3100, configuration information is written between the start tag and end tag of element name config. In the configuration information, the element name has resolution and prob. The tag of the element name resolution represents a time unit, and indicates that the time specified by a value is a processing system regarded as 1. The element name prob represents information related to the prober. An attribute id has the ID number of the prober; and name represents the name of the prober.

FIG. 32 is a diagram depicting an example of prober information. In FIG. 32, the prober information 3200 is output each time the state changes when the prober description 3000 is executed; and is information indicating the occurrence time, the ID number, the state value, and duration.

More specifically, the prober information 3200 has four columns in comma separate values (CSV) format. The first column indicates the occurrence time of an event. The second column indicates the ID number of the prober. The third column indicates the state value. The fourth column indicates the duration of the state indicated by the state value.

Here, although only an example of probing of the state value is depicted, the configuration information list 3100 and the prober information 3200 may be expanded, enabling the flow volume and the wait time to be measured. Further, the configuration information list 3100 and the prober information 3200 may be expanded as depicted in FIG. 33 to enable waveform registration by trace(VARIABLE,string) under asim_t.

FIG. 33 is a diagram depicting an example of waveform dump. In FIG. 33, setup is in asim_t and therefore, can be concisely written. If waveform dump is executed before sc_start( ), definition may be in virtual make( ), or in the constructor. As a result, waveform data, i.e., debugging information can be obtained.

A procedure of a simulation process of the simulation apparatus 900 according to the embodiment will be described.

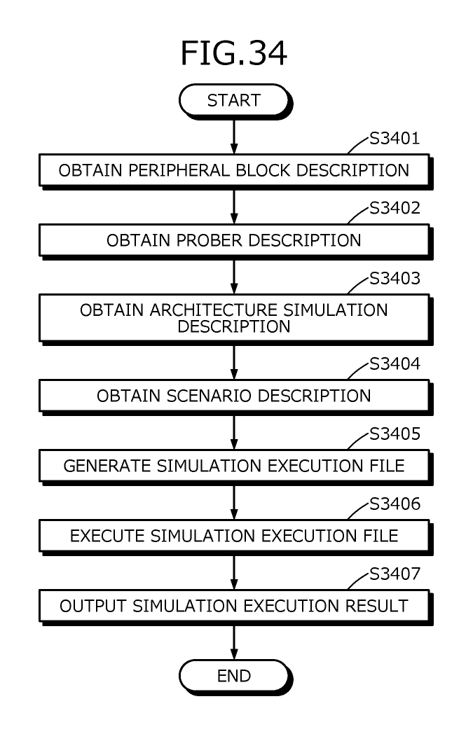

FIG. 34 is a flowchart depicting an example of a procedure of a simulation process of the simulation apparatus 900. In the flowchart depicted in FIG. 34, the simulation apparatus 900 obtains the peripheral block description of the calculation blocks B included in the system to be subject to evaluation (step S3401).

The simulation apparatus 900 obtains the prober description (step S3402). The simulation apparatus 900 further obtains the architecture simulation description (step S3403); and the scenario description (step S3404).

The simulation apparatus 900 generates a simulation execution file based on the obtained peripheral block description, prober description, architecture simulation description, and scenario description (step S3405).

The simulation apparatus 900 executes the generated simulation execution file (step S3406). The simulation apparatus 900 outputs a simulation execution result (step S3407), and ends a series of operation according to the flowchart. Thus, architecture simulation can be executed.

Analysis of the simulation execution results will be described. Analysis of the simulation execution results, for example, is performed interactively.

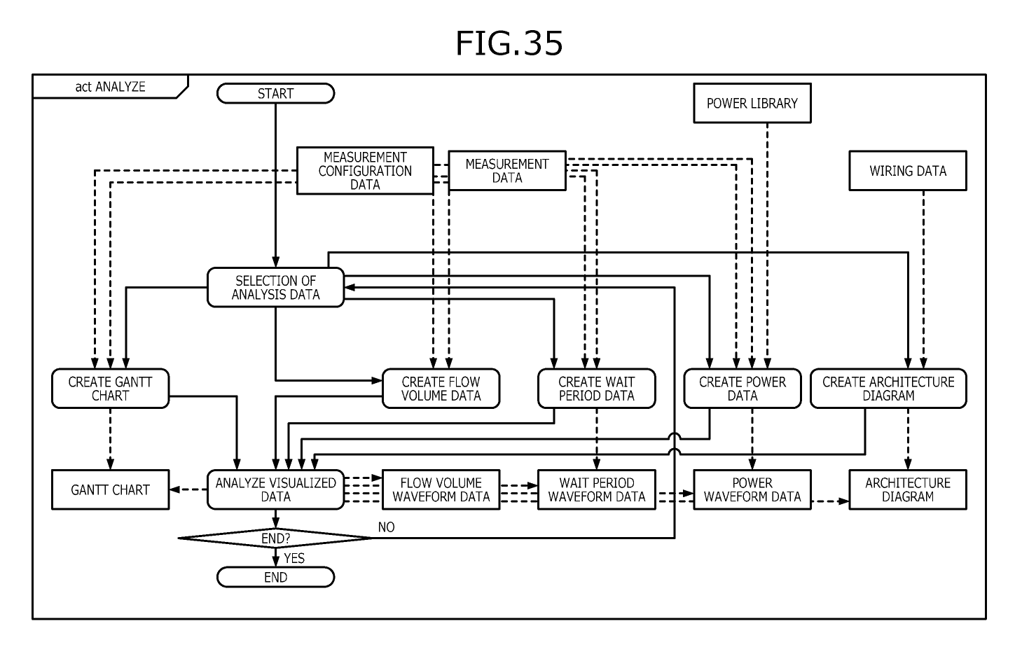

FIG. 35 is a diagram depicting an example of analysis of simulation execution results. In FIG. 35, a procedure of a process of analyzing simulation execution results is depicted. A power library is a library of a collection of power models that estimate power for the peripheral blocks, from the flow volume and state value.

A Gantt chart is a graph that visualizes the state of the peripheral blocks. Flow volume waveform data is a graph that for each peripheral block, is sectioned for each specified sample period and tabulates the flow volume and that can visualize the tabulation results. Wait period waveform data is a graph that for each peripheral block, is sectioned for each specified sample period and tabulates the wait time, and that can visualize the tabulation results.

Power waveform data is a graph that for each peripheral block, is sectioned for each specified sample period and tabulates the power, and that can visualize the tabulation results. An architecture diagram is a diagram that visualizes description representing architecture (for example, the top description 2200 depicted in FIG. 22).

The developer, for example, can use simulation execution results, to create a Gantt chart, flow volume data, wait period data, power data, and an architecture diagram. Further, to create such visualized diagrams, although a tool is used that analyzes and diagrams the language used in description, in the present embodiment, data that is to be diagramed is created at the time of architecture simulation and since this data is to be visualized, the complexity of the tool can be said to be a small scheme.

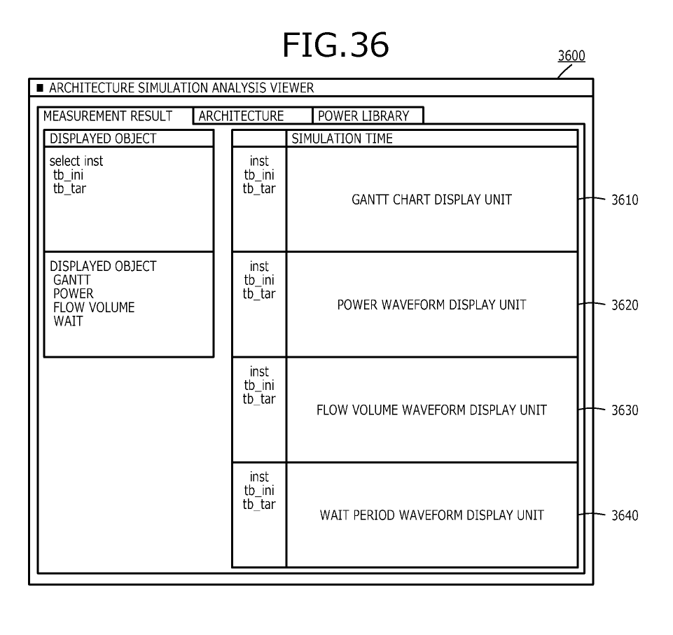

FIGS. 36, 37, and 38 are diagrams depicting an example of an architecture simulation analysis viewer. In FIG. 36, an architecture simulation analysis viewer 3600 includes a Gantt chart display unit 3610 that displays a Gantt chart, a power waveform display unit 3620 that displays power waveform data, a flow volume waveform display unit 3630 that displays flow volume waveform data, a wait period waveform display unit 3640 that displays wait period waveform data.

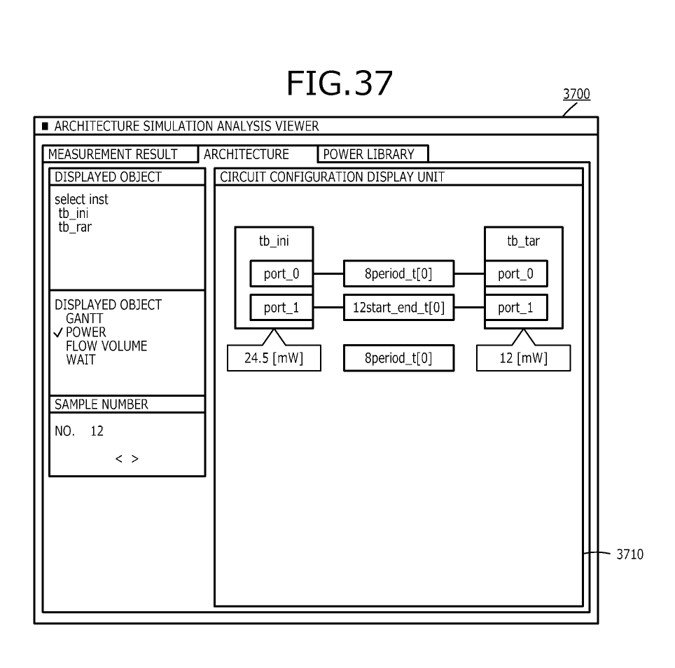

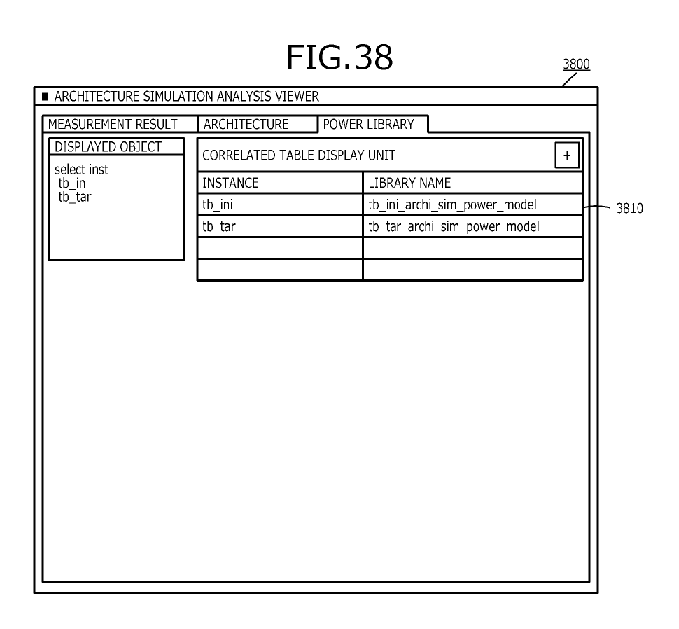

In FIG. 37, an architecture simulation analysis viewer 3700 includes a circuit configuration display unit 3710 that displays circuit configurations. In FIG. 38, an architecture simulation analysis viewer 3800 includes a correlated table display unit 3810 that displays a correlated table indicating correlations between instances and library names.

The architecture simulation analysis viewers 3600, 3700, and 3800 enable configuration of an architecture simulation analysis viewer. Further, since the architecture simulation analysis viewer 3700 can be used as an architecture simulation entry, the architecture simulation analysis viewer 3700 can be used further as an integrated environment.

As described, the simulation apparatus 900 according to the embodiment enables data of a specified size to be read from and written to the memory model MM, via the bus model BM; a delay equivalent to a specified cycle count to be caused to occur; and performance evaluation simulation of a system can be executed using the calculation block B that reproduces the calculation period. As a result, model description for the calculation blocks B in a system to be subject evaluation is simplified, the time consumed for and the burden related to the creation of a simulation model are reduced, and the simulation period can be shortened.

Further, the simulation apparatus 900 enables write access to be modeled by “data dispatch”, read access to be modeled by “data dispatch of a data order sheet” and “data dispatch of the ordered data”, whereby the simulation model can be simplified.

With the simulation apparatus 900, the bus model BM may have a negotiator model that has a buffer, and an arbiter model that exclusively controls access to the buffer. Further configuration may be such that the negotiator model, upon receiving a transfer request of a data order sheet, writes the data order sheet to the buffer under the exclusive control of the arbiter model, and after the data order sheet written to the buffer is written to the memory model MM, releases the buffer. As a result, when plural calculation blocks B access the bus model BM, simulation of exclusive control temporarily controlling the use of the bus model BM can be reproduced.

The simulation apparatus 900 enables simulation execution results to be output, such as wiring data (for example, the component information 2800), measurement configuration data (for example, the configuration information list 3100), and measurement data (for example, the prober information 3200).

Thus, the simulation apparatus 900 enables a decreased number of steps for creating a simulation model, whereby the shortened simulation period enables performance evaluation and power estimation during the initial design stage, which in turn enables advantageous information to be provided at business meetings and in determining specifications.

The simulation method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

The present embodiments facilitate efficient simulation to evaluate system performance.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein a simulation program that causes a computer to execute a process comprising:
obtaining an architecture model that includes a scenario block that issues an invocation signal to a plurality of blocks and detects an end signal from the plurality of blocks, a bus model that connects the plurality of blocks and a memory model and that controls access from the plurality of blocks to the memory model, and the plurality of blocks that access the memory model via the bus model and perform a calculation process;
obtaining for each block among the plurality of blocks, scenario description that indicates a count of the calculation process performed for a series of processes, a cycle count consumed for the calculation process, a read data volume for the calculation process, a write data volume for the calculation process, and an operation frequency of the block; and
executing simulation of the architecture model based on the architecture model and the scenario description.

2. The recording medium according to claim 1, wherein
the block includes a reading unit that performs a read process of reading data of a read data volume according to the calculation process, a calculating unit that causes a delay equivalent to a cycle count according to the calculation process, and a writing unit that performs a writing process of writing data of a write data volume according to the calculation process,
the reading unit, upon detecting an invocation signal from the scenario block or the calculating unit, performs the read process and issues an invocation signal to the calculating unit,
the calculating unit, based on an operation frequency of the block and after a period equivalent to the cycle count according to the calculation process elapses after detection of the invocation signal from the reading unit, issues an invocation signal to the writing unit and upon detecting an invocation signal from the writing unit, issues an invocation signal to the reading unit, and
the writing unit, after detecting the invocation signal from the calculating unit, performs the write process and issues an invocation signal to the calculating unit, and when the write process has been performed for a count of the calculation process, issues an end signal to the scenario block.

3. The recording medium according to claim 2, wherein
the bus model, upon receiving from the block, a transfer request for an order sheet for data of the read data volume, writes the order sheet to the memory model, and when the data of the read data volume is written thereto by the memory model, transmits the data of the read data volume to the block, and
the memory model, when the order sheet is written thereto by the bus model, writes the data of the read data volume to the bus model.

4. The recording medium according to claim 3, wherein
the bus model, upon receiving from the block, a transfer request for data of the write data volume, writes the data of the write data volume to the memory model.

5. The recording medium according to claim 4, wherein
the bus model has a negotiator model that has a buffer, and an arbiter that exclusively controls access to the buffer, and
the negotiator model, upon receiving the transfer request for the order sheet, writes the order sheet to the buffer under the exclusive control of the arbiter model, and after the order sheet written to the buffer is written to memory model, the negotiator model releases the buffer.

6. The recording medium according to claim 5, the process further comprising
executing a process of outputting execution results of the executed simulation of the architecture model.

7. A simulation apparatus comprising:
a processor that:
obtains an architecture model that includes a scenario block that issues an invocation signal to a plurality of blocks and detects an end signal from the plurality of blocks, a bus model that connects the plurality of blocks and a memory model and that controls access from the plurality of blocks to the memory model, and the plurality of blocks that access the memory model via the bus model and perform a calculation process;
obtains for each block among the plurality of blocks, scenario description that indicates a count of the calculation process performed for a series of processes, a cycle count consumed for the calculation process, a read data volume for the calculation process, a write data volume for the calculation process, and an operation frequency of the block; and
executes simulation of the architecture model based on the architecture model and the scenario description.

8. A simulation method executed by a computer, the simulation method comprising:
obtaining an architecture model that includes a scenario block that issues an invocation signal to a plurality of blocks and detects an end signal from the plurality of blocks, a bus model that connects the plurality of blocks and a memory model and that controls access from the plurality of blocks to the memory model, and the plurality of blocks that access the memory model via the bus model and perform a calculation process;
obtaining for each block among the plurality of blocks, scenario description that indicates a count of the calculation process performed for a series of processes, a cycle count consumed for the calculation process, a read data volume for the calculation process, a write data volume for the calculation process, and an operation frequency of the block; and
executing simulation of the architecture model based on the architecture model and the scenario description.

9. A bus circuit and a bus model comprising:
a circuit that has a unit that as an operation corresponding to a read request, transfers an order sheet for data from a given block, receives an order sheet from another block, and sends data corresponding thereto as a parcel; has a unit that as an operation corresponding to a write request, sends a parcel from a given block; has in a portion of data, control information of a transfer destination; and performs transfer, is a unit that interprets these and realizes desired data transfer.
